(19) United States
(12) Patent Application Publication
(10) Pub. No.: US 2022/0167229 A1
(43) Pub. Date: May 26, 2022

(54) CENTRALIZED AND DISTRIBUTED SELF-ORGANIZING NETWORKS FOR PHYSICAL CELL IDENTIFIER CONFIGURATION AND AUTOMATIC NEIGHBOR RELATION

(71) Applicant: Apple Inc., Cupertino, CA (US)

(72) Inventors: Joey Chou, Cupertino, CA (US); Yizhi Yao, Cupertino, CA (US)

(21) Appl. No.: 17/440,638

(22) PCT Filed: Jun. 4, 2020
(86) PCT No.: PCT/US2020/036139

§ 371 Date: Sep. 17, 2021

Related U.S. Application Data
(60) Provisional application No. 62/857,173, filed on Jun. 4, 2019.

(51) Int. Cl. H04W 36/00; H04W 24/02; H04W 48/16

(52) U.S. Cl. CPC H04W 36/0083; H04W 48/16; H04W 24/02

(57) ABSTRACT

Systems, devices, and techniques for self-organizing networks (SON) including automatic neighbor relation (ANR) management and physical cell identifier (PCI) configuration aspects are described. A described ANR technique includes enabling, by an ANR management function, a distributed ANR function at a node such as a gNB; receiving, by the ANR management function, a notification from the distributed ANR function indicating a change of a neighbor cell relation in a cell; and performing, by the ANR management function, an action based on the notification. Performing the action can include setting a blacklist of one or more neighbor cell relations, setting a whitelist of one or more neighbor cell relations, or changing one or more attributes of one or more neighbor cell relations.

### CROSS-REFERENCE TO RELATED APPLICATION

This disclosure claims the benefit of the priority of U.S. Provisional Patent Application No. 62/857,173, entitled “CENTRALIZED AND DISTRIBUTED SELF-ORGANIZING NETWORKS (SON) FOR PHYSICAL-LAYER CELL IDENTIFIER (PCI) CONFIGURATION AND AUTOMATIC NEIGHBOR RELATION (ANR)” and filed on Jun. 4, 2019. The above-identified application is incorporated herein by reference in its entirety.

### TECHNICAL FIELD

This disclosure relates generally to wireless communication systems.

### BACKGROUND

Base stations, such as a node of radio access network (RAN), can wirelessly communicate with wireless devices such as user equipment (UE). A downlink (DL) transmission refers to a communication from the base station to the wireless device. An uplink (UL) transmission refers to a communication from the wireless device to another device such as the base station. Base stations can transmit control signaling in order to control wireless devices that operate within their network.

### SUMMARY

Systems, devices, and techniques for self-organizing networks (SON) including automatic neighbor relation (ANR) management and physical cell identifier (PCI) configuration aspects are described. A described ANR technique includes enabling, by an ANR management function, a distributed ANR function at a node such as a gNB; receiving, by the ANR management function, a notification from the distributed ANR function indicating a change of a neighbor cell relation (NCR) in a cell such as a 5G NR cell; and performing, by the ANR management function, an action based on the notification. Performing the action can include setting a blacklist of one or more neighbor cell relations, setting a whitelist of one or more neighbor cell relations, or changing one or more attributes of one or more neighbor cell relations. Other implementations include corresponding systems, apparatus, communication processor(s), and computer programs to perform the actions of methods defined by instructions encoded on computer readable storage.

These and other implementations can include one or more of the following features. Implementations can include detecting, by the distributed ANR function, a new neighbor cell relation based on the notification; and performing an update to a neighbor cell relation table (NCRT) by adding the new neighbor cell relation to the neighbor cell relation table. The new neighbor cell relation can be an inter or intra neighbor cell relation. Implementations can include sending, by the distributed ANR function, a notify creation message to notify the ANR management function that the new neighbor cell relation has been added to the neighbor cell relation table.

Implementations can include detecting, by the distributed ANR function, that an existing neighbor cell relation has been removed based on the notification; and performing an update to a neighbor cell relation table by deleting the existing neighbor cell relation from the neighbor cell relation table. The existing neighbor cell relation can be an inter or intra neighbor cell relation. Implementations can include sending, by the distributed ANR function, a notify deletion message to notify the ANR management function that the existing neighbor cell relation has been removed from the neighbor cell relation table.

In some implementations, the ANR management function consumes a management service for network function provisioning with a modify managed object instance (MOI) attributes operation, such as modifyMOIAttributes, to modify one or more ANR attributes. The one or more ANR attributes can collectively include an attribute to control whether the node is allowed to remove a neighbor cell relation from a neighbor cell relation table, an attribute to control whether the node is allowed to use a neighbor cell relation for a handover, or both. In some implementations, the ANR management function consumes a management service for network function provisioning with a create MOI operation, such as createMOI, to add whitelist or blacklist information to a neighbor cell relation table.

In some implementations, a wireless network can provide a distributed PCI configuration function performed by a node. Implementations can include receiving, by a distributed PCI configuration function performed by the node, a list of PCI values for use by a NR cell from a PCI management and control function; selecting a PCI value from the list of PCI values received from the PCI management and control function; and sending, to the PCI management and control function, a notification that indicates the selected PCI value. In some implementations, the distributed PCI configuration function uses a producer of a management service for network function provisioning to perform an operation such as notifyMOIAttributeValueChange to send a notification regarding an attribute value change for a managed object instance. In some implementations, the distributed PCI configuration function is enabled by the PCI management and control function.

Another ANR technique in a wireless communication network includes collecting, by a centralized ANR optimization function performed by one or more processors of the wireless communication network, performance measurements for neighbor cells and neighbor candidate cells of a cell; determining whether to update a neighbor cell relation table based on at least a portion of the performance measurements; determining an action to perform on the neighbor cell relation table based on a determination to update the neighbor cell relation table; and performing the action to update the neighbor cell relation table. Other implementations include corresponding systems, apparatus, communication processor(s), and computer programs to perform the actions of methods defined by instructions encoded on computer readable storage.

These and other implementations can include one or more of the following features. The neighbor cells can include a NR cell. The wireless communication network can include a gNB that controls the NR cell. In some implementations, the wireless communication network includes a first radio access technology (RAT) and a second RAT. The performance measurements can include reference signal received power (RSRP) measurement results. The RSRP measurement results can be generated from a measurement result list report in accordance with the first RAT for intra-RAT neighbor relations such as reported by MeasResultListNR, or a measurement result list report in accordance with the second RAT for inter-RAT neighbor relations such as reported by MeasResultListEUTRA. Determining the action to perform on the neighbor cell relation table can include determining that the action is a delete action based on a determination that one or more RSRP measurement values of a neighbor cell are less than a threshold. Determining the action to perform on the neighbor cell relation table can include determining that the action is an add action based on a determination that one or more RSRP measurement values of a neighbor candidate cell are greater than a threshold.

In some implementations, the centralized ANR optimization function is configured to add a new relation to the neighbor cell relation table by performing a create MOI operation to create an information object class (IOC) that represents a neighbor cell relation from a source cell to a target cell. In some implementations, the centralized ANR optimization function is configured to modify an attribute in the neighbor cell relation table by performing a modify MOI attributes operation to modify an IOC that represents a neighbor cell relation from a source cell to a target cell. In some implementations, the centralized ANR optimization function is configured to remove an existing relation from the neighbor cell relation table by performing a delete MOI operation to delete an IOC that represents the existing neighbor cell relation from a source cell to a target cell.

In some implementations, the ANR optimization function is triggered periodically. In some implementations, the ANR optimization function is triggered based on a detection that a cell of the wireless communication network is experiencing performance issues with respect to another cell of the wireless communication network.

A wireless network can provide in some implementations a distributed PCI configuration function performed by equipment within the wireless network. Implementations can include collecting, by a centralized PCI configuration function, PCI related measurements; detecting, based on the PCI related measurements, a newly deployed NR cell or a NR cell associated with a PCI conflict; and configuring a specific PCI value or a list values for the newly deployed NR cell or reconfiguring a PCI value or a list values for the NR cell associated with the PCI conflict.

In some implementations, the centralized PCI configuration function is triggered periodically. In some implementations, the centralized PCI configuration function is triggered based on a detection that a cell of the wireless communication network is associated with a PCI conflict. In some implementations, the centralized PCI configuration function is triggered based on the activation or deactivation of one or more NR cells. In some implementations, the PCI related measurements include measurements included in one or more measurement reports reported by one or more nodes. The one or more measurement reports can include a physical cell identifier and a measurement results element. In some implementations, the centralized PCI configuration function consumes a management service for network function provisioning with a modify managed object instance operation to reconfigure the PCI value or a list values for the NR cell associated with the PCI conflict.

The details of one or more implementations are set forth in the accompanying drawings and the description below. Other features and advantages will be apparent from the description and drawings, and from the claims.

### BRIEF DESCRIPTION OF DRAWINGS

FIG. 1 illustrates an example of a wireless communication system.

FIG. 2 illustrates an example architecture of a system including a core network.

FIG. 3 illustrates another example architecture of a system including a core network.

FIG. 4 illustrates an example of infrastructure equipment.

FIG. 5 illustrates an example of a platform or device.

FIG. 6 illustrates example protocol functions that may be implemented in wireless communication systems.

FIGS. 7A and 7B illustrate diagrams of different examples of ANR architectures.

FIGS. 8A and 8B illustrate diagrams of different examples of PCI configuration architectures.

FIG. 9 illustrates a flowchart of a process performed by a distributed ANR management function in a wireless network.

FIG. 10 illustrates a flowchart of a process performed by a centralized ANR optimization function in a wireless network.

Like reference symbols in the various drawings indicate like elements.

### DETAILED DESCRIPTION

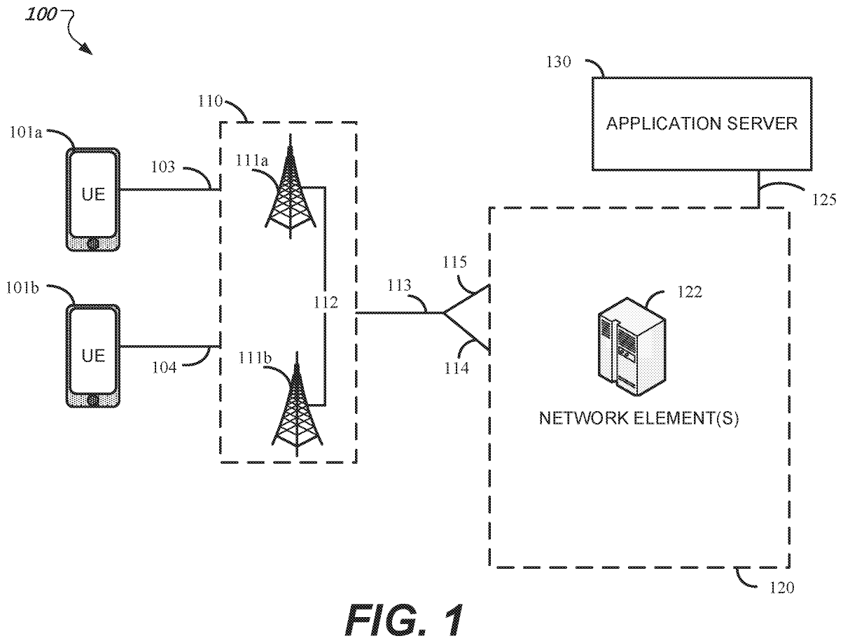

FIG. 1 illustrates an example of a wireless communication system 100. For purposes of convenience and without limitation, the example system 100 is described in the context of the LTE and 5G NR communication standards as defined by the Third Generation Partnership Project (3GPP) technical specifications. However, other types of communication standards are possible.

The system 100 includes UE 101a and UE 101b (collectively referred to as the “UEs 101”). In this example, the UEs 101 are illustrated as smartphones (e.g., handheld touchscreen mobile computing devices connectable to one or more cellular networks). In other examples, any of the UEs 101 may include other mobile or non-mobile computing devices, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M) devices, Internet of Things (IoT) devices, or combinations of them, among others.

In some implementations, any of the UEs 101 may be IoT UEs, which can include a network access layer designed for low-power IoT applications utilizing short-lived UE connections. An IoT UE can utilize technologies such as M2M or MTC for exchanging data with an MTC server or device using, for example, a public land mobile network (PLMN), proximity services (ProSe), device-to-device (D2D) communication, sensor networks, IoT networks, or combinations of them, among others. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages or status updates) to facilitate the connections of the IoT network.

The UEs 101 are configured to connect (e.g., communicatively couple) with RAN 110. The RAN 110 can include one or more RAN nodes 111a and 111b (collectively referred to as “RAN nodes 111” or “RAN node 111”). In some implementations, the RAN 110 may be a next generation RAN (NG RAN), an evolved UMTS terrestrial radio access network (E-UTRAN), or a legacy RAN, such as a UMTS terrestrial radio access network (UTRAN) or a GSM EDGE radio access network (GERAN). As used herein, the term “NG RAN” may refer to a RAN 110 that operates in a 5G NR system 100, and the term “E-UTRAN” may refer to a RAN 110 that operates in an LTE or 4G system 100.

To connect to the RAN 110, the UEs 101 utilize connections (or channels) 103 and 104, respectively, each of which may include a physical communications interface or layer, as described below. In this example, the connections 103 and 104 are illustrated as an air interface to enable communicative coupling, and can be consistent with cellular communications protocols, such as a global system for mobile communications (GSM) protocol, a code-division multiple access (CDMA) network protocol, a push-to-talk (PTT) protocol, a PTT over cellular (POC) protocol, a universal mobile telecommunications system (UMTS) protocol, a 3GPP LTE protocol, a 5G NR protocol, or combinations of them, among other communication protocols.

The RAN 110 can include one or more RAN nodes 111a and 111b (collectively referred to as “RAN nodes 111” or “RAN node 111”) that enable the connections 103 and 104. As used herein, the terms “access node,” “access point,” or the like may describe equipment that provides the radio baseband functions for data or voice connectivity, or both, between a network and one or more users. These access nodes can be referred to as base stations (BS), gNodeBs, gNBs, eNodeBs, eNBs, NodeBs, RAN nodes, road side units (RSUs), and the like, and can include ground stations (e.g., terrestrial access points) or satellite stations providing coverage within a geographic area (e.g., a cell), among others. As used herein, the term “NG RAN node” may refer to a RAN node 111 that operates in a 5G NR system 100 (for example, a gNB), and the term “E-UTRAN node” may refer to a RAN node 111 that operates in an LTE or 4G system 100 (e.g., an eNB). In some implementations, the RAN nodes 111 may be implemented as one or more of a dedicated physical device such as a macrocell base station, or a low power (LP) base station for providing femtocells, picocells or other like cells having smaller coverage areas, smaller user capacity, or higher bandwidth compared to macrocells.

The RAN nodes 111 and the UEs 101 can be configured for multiple-input and multiple-output (MIMO) communications, including single or multi-beam communications. For example, a UE 101 can receive transmissions from one RAN node 111 at a time or from multiple RAN nodes 111 at the same time. The RAN nodes 111 and the UEs 101 can use beamforming for the UL, DL, or both. For example, one or more RAN nodes 111 can transmit (Tx) a beam towards a UE 101, and the UE 101 can receive data via one or more receive (Rx) beams at the same time. In some implementations, each of the RAN nodes 111 can be configured as a transmission and reception point (TRP). The RAN 110 can provide signaling for configuring beamforming such as by providing transmission configuration indicator (TCI) state configuration information.

Any of the RAN nodes 111 can terminate the air interface protocol and can be the first point of contact for the UEs 101. In some implementations, any of the RAN nodes 111 can fulfill various logical functions for the RAN 110 including, but not limited to, radio network controller (RNC) functions such as radio bearer management, uplink and downlink dynamic radio resource management and data packet scheduling, and mobility management.

In some implementations, the UEs 101 can be configured to communicate using orthogonal frequency division multiplexing (OFDM) communication signals with each other or with any of the RAN nodes 111 over a multicarrier communication channel in accordance with various communication techniques, such as, but not limited to, OFDMA communication techniques (e.g., for downlink communications) or SC-FDMA communication techniques (e.g., for uplink communications), although the scope of the techniques described here not limited in this respect. The OFDM signals can comprise a plurality of orthogonal subcarriers.

In some implementations, a downlink resource grid can be used for downlink transmissions from any of the RAN nodes 111 to the UEs 101, while uplink transmissions can utilize similar techniques. The grid can be a frequency grid or a time-frequency grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid can be denoted as a resource element (RE). Each resource grid can include a number of resource blocks, which describe the mapping of certain physical channels to resource elements. A resource block (RB) can include a collection of resource elements; in the frequency domain, this may represent the smallest quantity of resources that currently can be allocated. Physical downlink and uplink channels can be conveyed using such resource blocks. In some cases, a RB can be referred to as a physical resource block (PRB).

The RAN nodes 111 can transmit to the UEs 101 over one or more DL channels. Various examples of DL communication channels include a physical broadcast channel (PBCH), physical downlink control channel (PDCCH), and physical downlink shared channel (PDSCH). The PDSCH can carry user data and higher-layer signaling to the UEs 101. Other types of downlink channels are possible. The UEs 101 can transmit to the RAN nodes 111 over one or more UL channels. Various examples of UL communication channels include physical uplink shared channel (PUSCH), physical uplink control channel (PUCCH), and physical random access channel (PRACH). Other types of uplink channels are possible. Devices such as the RAN nodes 111 and the UEs 101 can transmit reference signals. Examples of reference signals include a synchronization signal block (SSB), sounding reference signal (SRS), channel state information reference signal (CSI-RS), demodulation reference signal (DMRS or DM-RS), and phase tracking reference signal (PTRS). Other types of reference signals are possible.

A channel such as PDCCH can convey scheduling information of different types for one or more downlink and uplink channels. Scheduling information can include downlink resource scheduling, uplink power control instructions, uplink resource grants, and indications for paging or system information. The RAN nodes 111 can transmit one or more downlink control information (DCI) messages on the PDCCH to provide scheduling information, such as allocations of one or more PRBs. In some implementations, a DCI message transports control information such as requests for aperiodic CQI reports, UL power control commands for a channel, and a notification for a group of UEs 101 of a slot format. Downlink scheduling (e.g., assigning control and shared channel resource blocks to the UE 101b within a cell) may be performed at any of the RAN nodes 111 based on channel quality information fed back from any of the UEs 101. The downlink resource assignment information may be sent on the PDCCH used for (e.g., assigned to) each of the UEs 101 or a group of UEs. In some implementations, the PDCCH carries information about the transport format and resource allocations related to the PDSCH channel, among other things. It may also inform the UEs 101 about the transport format, resource allocation, and hybrid automatic repeat request (HARQ) information for providing HARQ feedback on an uplink channel based on a PDSCH reception.

Downlink and uplink transmissions can occur in one or more component carriers (CCs). One or more bandwidth part (BWP) configurations for each component carrier can be configured. In some implementations, a DL BWP includes at least one control resource set (CORESET). In some implementations, a CORESET includes one or more PRBs in a frequency domain, and one or more OFDM symbols in a time domain. In some implementations, channels such as PDCCH can be transmitted via one or more CORESETs, with each CORESET corresponding to a set of time-frequency resources. CORESET information can be provided to a UE 101, and the UE 101 can monitor time-frequency resources associated with one or more CORESETs to receive a PDCCH transmission.

In some implementations, the PDSCH carries user data and higher-layer signaling to the UEs 101. Typically, DL scheduling (assigning control and shared channel resource blocks to the UE 101 within a cell) may be performed at any of the RAN nodes 111 based on channel quality information fed back from any of the UEs 101. The downlink resource assignment information may be sent on the PDCCH used for (e.g., assigned to) each of the UEs 101. The PDCCH can use control channel elements (CCEs) to convey control information (e.g., DCI), and a set of CCEs may be referred to a “control region.” Control channels are formed by aggregation of one or more CCEs, where different code rates for the control channels are realized by aggregating different numbers of CCEs. Before being mapped to REs, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical REs known as resource element groups (REGs). The PDCCH can be transmitted using one or more CCEs, depending on the size of the DCI and the channel condition. There can be four or more different PDCCH formats defined with different numbers of CCEs (e.g., aggregation level, L=1, 2, 4, or 8 in LTE and L=1, 2, 4, 8, or 16 in NR). The UE 101 monitors a set of PDCCH candidates on one or more activated serving cells as configured by higher layer signaling for control information (e.g., DCI), where monitoring implies attempting to decode each of the PDCCHs (or PDCCH candidates) in the set according to all the monitored DCI formats. The UEs 101 monitor (or attempt to decode) respective sets of PDCCH candidates in one or more configured monitoring occasions according to the corresponding search space configurations.

In some NR implementations, the UEs 101 monitor (or attempt to decode) respective sets of PDCCH candidates in one or more configured monitoring occasions in one or more configured CORESETs according to the corresponding search space configurations. A CORESET may include a set of PRBs with a time duration of 1 to 3 OFDM symbols. The UEs 101 can be configured with multiple CORESETS where each CORESET is associated with a CCE-to-REG mapping. Interleaved and non-interleaved CCE-to-REG mapping are supported in a CORESET. Each REG carrying a PDCCH carries its own DMRS.

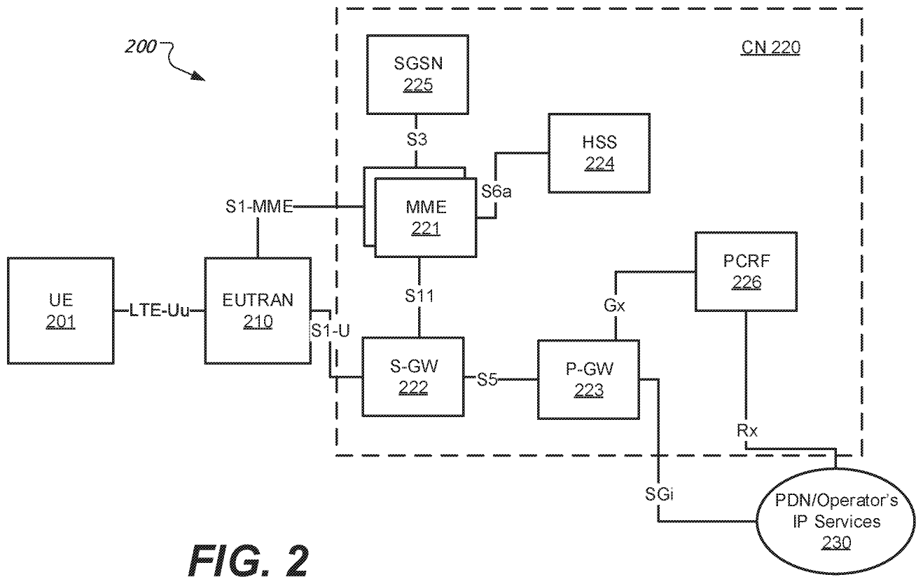

The RAN nodes 111 are configured to communicate with one another using an interface 112. In examples, such as where the system 100 is an LTE system (e.g., when the core network 120 is an evolved packet core (EPC) network as shown in FIG. 2), the interface 112 may be an X2 interface 112. The X2 interface may be defined between two or more RAN nodes 111 (e.g., two or more eNBs and the like) that connect to the EPC 120, or between two eNBs connecting to EPC 120, or both. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a master eNB to a secondary eNB; information about successful in sequence delivery of PDCP protocol data units (PDUs) to a UE 101 from a secondary eNB for user data; information of PDCP PDUs that were not delivered to a UE 101; information about a current minimum desired buffer size at the secondary eNB for transmitting to the UE user data, among other information. The X2-C may provide intra-LTE access mobility functionality, including context transfers from source to target eNBs or user plane transport control; load management functionality; inter-cell interference coordination functionality, among other functionality.

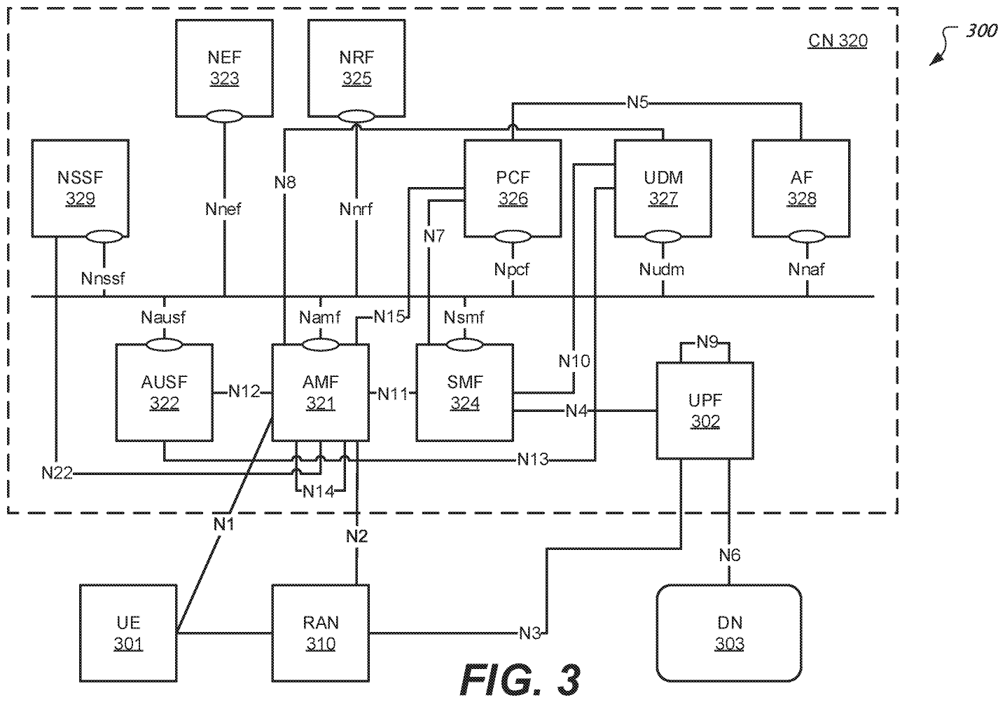

In some implementations, such as where the system 100 is a 5G NR system (e.g., when the core network 120 is a 5G core network as shown in FIG. 3), the interface 112 may be an Xn interface 112. The Xn interface may be defined between two or more RAN nodes 111 (e.g., two or more gNBs and the like) that connect to the 5G core network 120, between a RAN node 111 (e.g., a gNB) connecting to the 5G core network 120 and an eNB, or between two eNBs connecting to the 5G core network 120, or combinations of them. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 101 in a connected mode (e.g., CM-CONNECTED) including functionality to manage the UE mobility for connected mode between one or more RAN nodes 111, among other functionality. The mobility support may include context transfer from an old (source) serving RAN node 111 to new (target) serving RAN node 111, and control of user plane tunnels between old (source) serving RAN node 111 to new (target) serving RAN node 111. A protocol stack of the Xn-U may include a transport network layer built on Internet Protocol (IP) transport layer, and a GPRS tunneling protocol for user plane (GTP-U) layer on top of a user datagram protocol (UDP) or IP layer(s), or both, to carry user plane PDUs. The Xn-C protocol stack may include an application layer signaling protocol (referred to as Xn Application Protocol (Xn-AP or XnAP)) and a transport network layer that is built on a stream control transmission protocol (SCTP). The SCTP may be on top of an IP layer, and may provide the guaranteed delivery of application layer messages. In the transport IP layer, point-to-point transmission is used to deliver the signaling PDUs. In other implementations, the Xn-U protocol stack or the Xn-C protocol stack, or both, may be same or similar to the user plane and/or control plane protocol stack(s) shown and described herein.

The RAN 110 is shown to be communicatively coupled to a core network 120 (referred to as a “CN 120”). The CN 120 includes one or more network elements 122, which are configured to offer various data and telecommunications services to customers/subscribers (e.g., users of UEs 101) who are connected to the CN 120 using the RAN 110. The components of the CN 120 may be implemented in one physical node or separate physical nodes and may include components to read and execute instructions from a machine-readable or computer-readable medium (e.g., a non-transitory machine-readable storage medium). In some implementations, network functions virtualization (NFV) may be used to virtualize some or all of the network node functions described here using executable instructions stored in one or more computer-readable storage mediums, as described in further detail below. A logical instantiation of the CN 120 may be referred to as a network slice, and a logical instantiation of a portion of the CN 120 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more network components or functions, or both.

An application server 130 may be an element offering applications that use IP bearer resources with the core network (e.g., UMTS packet services (PS) domain, LTE PS data services, among others). The application server 130 can also be configured to support one or more communication services (e.g., VoIP sessions, PTT sessions, group communication sessions, social networking services, among others) for the UEs 101 using the CN 120. The application server 130 can use an IP communications interface 125 to communicate with one or more network elements 122.

In some implementations, the CN 120 may be a 5G core network (referred to as “5GC 120” or “5G core network 120”), and the RAN 110 may be connected with the CN 120 using a next generation interface 113. In some implementations, the next generation interface 113 may be split into two parts, an next generation user plane (NG-U) interface 114, which carries traffic data between the RAN nodes 111 and a user plane function (UPF), and the S1 control plane (NG-C) interface 115, which is a signaling interface between the RAN nodes 111 and access and mobility management functions (AMFs). Examples where the CN 120 is a 5G core network are discussed in more detail with regard to FIG. 3.

In some implementations, the CN 120 may be an EPC (referred to as “EPC 120” or the like), and the RAN 110 may be connected with the CN 120 using an S1 interface 113. In some implementations, the S1 interface 113 may be split into two parts, an S1 user plane (S1-U) interface 114, which carries traffic data between the RAN nodes 111 and the serving gateway (S-GW), and the S1-MME interface 115, which is a signaling interface between the RAN nodes 111 and mobility management entities (MMEs).

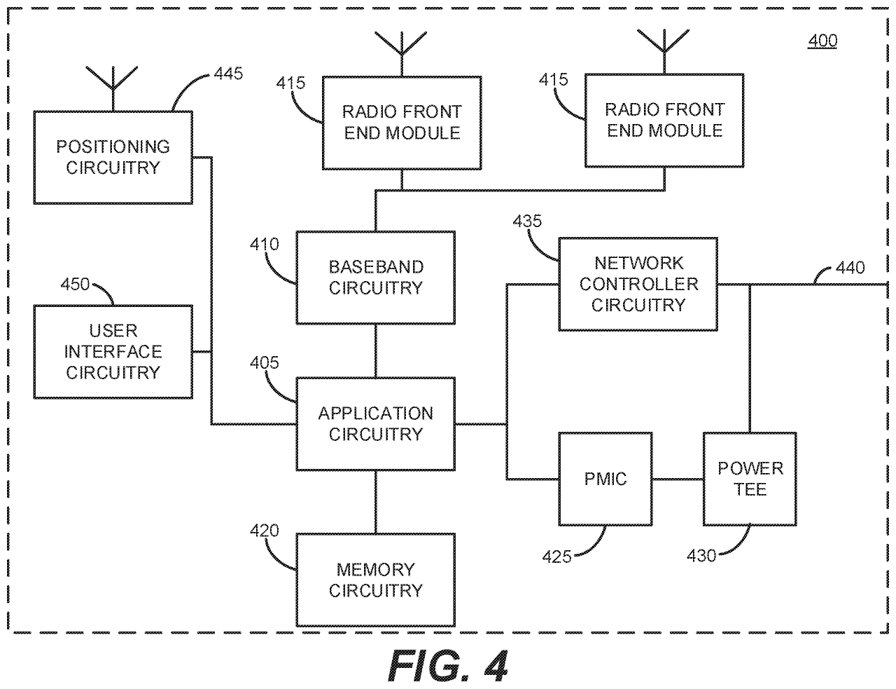

In some implementations, some or all of the RAN nodes 111 may be implemented as one or more software entities running on server computers as part of a virtual network, which may be referred to as a cloud RAN (CRAN) or a virtual baseband unit pool (vBBUP). The CRAN or vBBUP may implement a RAN function split, such as a packet data convergence protocol (PDCP) split in which radio resource control (RRC) and PDCP layers are operated by the CRAN/vBBUP and other layer two (e.g., data link layer) protocol entities are operated by individual RAN nodes 111; a medium access control (MAC)/physical layer (PHY) split in which RRC, PDCP, MAC, and radio link control (RLC) layers are operated by the CRAN/vBBUP and the PHY layer is operated by individual RAN nodes 111; or a “lower PHY” split in which RRC, PDCP, RLC, and MAC layers and upper portions of the PHY layer are operated by the CRAN/vBBUP and lower portions of the PHY layer are operated by individual RAN nodes 111. This virtualized framework allows the freed-up processor cores of the RAN nodes 111 to perform, for example, other virtualized applications. In some implementations, an individual RAN node 111 may represent individual gNB distributed units (DUs) that are connected to a gNB central unit (CU) using individual F1 interfaces (not shown in FIG. 1). In some implementations, the gNB-DUs may include one or more remote radio heads or RFEMs (see, e.g., FIG. 4), and the gNB-CU may be operated by a server that is located in the RAN 110 (not shown) or by a server pool in a similar manner as the CRAN/vBBUP. Additionally or alternatively, one or more of the RAN nodes 111 may be next generation eNBs (ng-eNBs), including RAN nodes that provide E-UTRA user plane and control plane protocol terminations toward the UEs 101, and are connected to a 5G core network (e.g., core network 120) using a next generation interface.

In vehicle-to-everything (V2X) scenarios, one or more of the RAN nodes 111 may be or act as RSUs. The term “Road Side Unit” or “RSU” refers to any transportation infrastructure entity used for V2X communications. A RSU may be implemented in or by a suitable RAN node or a stationary (or relatively stationary) UE, where a RSU implemented in or by a UE may be referred to as a “UE-type RSU,” a RSU implemented in or by an eNB may be referred to as an “eNB-type RSU,” a RSU implemented in or by a gNB may be referred to as a “gNB-type RSU,” and the like. In some implementations, an RSU is a computing device coupled with radio frequency circuitry located on a roadside that provides connectivity support to passing vehicle UEs 101 (vUEs 101). The RSU may also include internal data storage circuitry to store intersection map geometry, traffic statistics, media, as well as applications or other software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) or provide connectivity to one or more cellular networks to provide uplink and downlink communications, or both. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller or a backhaul network, or both.

FIG. 2 illustrates an example architecture of a system 200 including a first CN 220. In this example, the system 200 may implement the LTE standard such that the CN 220 is an EPC 220 that corresponds with CN 120 of FIG. 1. Additionally, the UE 201 may be the same or similar as the UEs 101 of FIG. 1, and the E-UTRAN 210 may be a RAN that is the same or similar to the RAN 110 of FIG. 1, and which may include RAN nodes 111 discussed previously. The CN 220 may comprise MMEs 221, an S-GW 222, a PDN gateway (P-GW) 223, a high-speed packet access (HSS) function 224, and a serving GPRS support node (SGSN) 225.

The MMEs 221 may be similar in function to the control plane of legacy SGSN, and may implement mobility management (MM) functions to keep track of the current location of a UE 201. The MMEs 221 may perform various mobility management procedures to manage mobility aspects in access such as gateway selection and tracking area list management. Mobility management (also referred to as “EPS MM” or “EMM” in E-UTRAN systems) may refer to all applicable procedures, methods, data storage, and other aspects that are used to maintain knowledge about a present location of the UE 201, provide user identity confidentiality, or perform other like services to users/subscribers, or combinations of them, among others. Each UE 201 and the MME 221 may include an EMM sublayer, and a mobility management context may be established in the UE 201 and the MME 221 when an attach procedure is successfully completed. The mobility management context may be a data structure or database object that stores mobility management-related information of the UE 201. The MMEs 221 may be coupled with the HSS 224 using a S6a reference point, coupled with the SGSN 225 using a S3 reference point, and coupled with the S-GW 222 using a S11 reference point.

The SGSN 225 may be a node that serves the UE 201 by tracking the location of an individual UE 201 and performing security functions. In addition, the SGSN 225 may perform Inter-EPC node signaling for mobility between 2G/3G and E-UTRAN 3GPP access networks; PDN and S-GW selection as specified by the MMEs 221; handling of UE 201 time zone functions as specified by the MMEs 221; and MME selection for handovers to E-UTRAN 3GPP access network, among other functions. The S3 reference point between the MMEs 221 and the SGSN 225 may enable user and bearer information exchange for inter-3GPP access network mobility in idle or active states, or both.

The HSS 224 may include a database for network users, including subscription-related information to support the network entities' handling of communication sessions. The EPC 220 may include one or more HSSs 224 depending on the number of mobile subscribers, on the capacity of the equipment, on the organization of the network, or combinations of them, among other features. For example, the HSS 224 can provide support for routing, roaming, authentication, authorization, naming/addressing resolution, location dependencies, among others. A S6a reference point between the HSS 224 and the MMEs 221 may enable transfer of subscription and authentication data for authenticating or authorizing user access to the EPC 220 between HSS 224 and the MMEs 221.

The S-GW 222 may terminate the S1 interface 113 (“S1-U” in FIG. 2) toward the RAN 210, and may route data packets between the RAN 210 and the EPC 220. In addition, the S-GW 222 may be a local mobility anchor point for inter-RAN node handovers and also may provide an anchor for inter-3GPP mobility. Other responsibilities may include lawful intercept, charging, and some policy enforcement. The S11 reference point between the S-GW 222 and the MMEs 221 may provide a control plane between the MMEs 221 and the S-GW 222. The S-GW 222 may be coupled with the P-GW 223 using a S5 reference point.

The P-GW 223 may terminate a SGi interface toward a PDN 230. The P-GW 223 may route data packets between the EPC 220 and external networks such as a network including the application server 130 (sometimes referred to as an “AF”) using an IP communications interface 125 (see, e.g., FIG. 1). In some implementations, the P-GW 223 may be communicatively coupled to an application server (e.g., the application server 130 of FIG. 1 or PDN 230 in FIG. 2) using an IP communications interface 125 (see, e.g., FIG. 1). The S5 reference point between the P-GW 223 and the S-GW 222 may provide user plane tunneling and tunnel management between the P-GW 223 and the S-GW 222. The S5 reference point may also be used for S-GW 222 relocation due to UE 201 mobility and if the S-GW 222 needs to connect to a non-collocated P-GW 223 for the required PDN connectivity. The P-GW 223 may further include a node for policy enforcement and charging data collection (e.g., PCEF (not shown)). Additionally, the SGi reference point between the P-GW 223 and the packet data network (PDN) 230 may be an operator external public, a private PDN, or an intra operator packet data network, for example, for provision of IMS services. The P-GW 223 may be coupled with a policy control and charging rules function (PCRF) 226 using a Gx reference point.

PCRF 226 is the policy and charging control element of the EPC 220. In a non-roaming scenario, there may be a single PCRF 226 in the Home Public Land Mobile Network (HPLMN) associated with a UE 201's Internet Protocol Connectivity Access Network (IP-CAN) session. In a roaming scenario with local breakout of traffic, there may be two PCRFs associated with a UE 201's IP-CAN session, a Home PCRF (H-PCRF) within an HPLMN and a Visited PCRF (V-PCRF) within a Visited Public Land Mobile Network (VPLMN). The PCRF 226 may be communicatively coupled to the application server 230 using the P-GW 223. The application server 230 may signal the PCRF 226 to indicate a new service flow and select the appropriate quality of service (QoS) and charging parameters. The PCRF 226 may provision this rule into a PCEF (not shown) with the appropriate traffic flow template (TFT) and QoS class identifier (QCI), which commences the QoS and charging as specified by the application server 230. The Gx reference point between the PCRF 226 and the P-GW 223 may allow for the transfer of QoS policy and charging rules from the PCRF 226 to PCEF in the P-GW 223. A Rx reference point may reside between the PDN 230 (or “AF 230”) and the PCRF 226.

FIG. 3 illustrates an architecture of a system 300 including a second CN 320. The system 300 is shown to include a UE 301, which may be the same or similar to the UEs 101 and UE 201 discussed previously; a RAN 310, which may be the same or similar to the RAN 110 and RAN 210 discussed previously, and which may include RAN nodes 111 discussed previously; and a data network (DN) 303, which may be, for example, operator services, Internet access or 3rd party services; and a 5GC 320. The 5GC 320 may include an authentication server function (AUSF) 322; an access and mobility management function (AMF) 321; a session management function (SMF) 324; a network exposure function (NEF) 323; a policy control function (PCF) 326; a network repository function (NRF) 325; a unified data management (UDM) function 327; an AF 328; a user plane function (UPF) 302; and a network slice selection function (NSSF) 329.

The UPF 302 may act as an anchor point for intra-RAT and inter-RAT mobility, an external PDU session point of interconnect to DN 303, and a branching point to support multi-homed PDU session. The UPF 302 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform Uplink Traffic verification (e.g., SDF to QoS flow mapping), transport level packet marking in the uplink and downlink, and perform downlink packet buffering and downlink data notification triggering. UPF 302 may include an uplink classifier to support routing traffic flows to a data network. The DN 303 may represent various network operator services, Internet access, or third party services. DN 303 may include, or be similar to, application server 130 discussed previously. The UPF 302 may interact with the SMF 324 using a N4 reference point between the SMF 324 and the UPF 302.

The AUSF 322 stores data for authentication of UE 301 and handle authentication-related functionality. The AUSF 322 may facilitate a common authentication framework for various access types. The AUSF 322 may communicate with the AMF 321 using a N12 reference point between the AMF 321 and the AUSF 322, and may communicate with the UDM 327 using a N13 reference point between the UDM 327 and the AUSF 322. Additionally, the AUSF 322 may exhibit a Nausf service-based interface.

The AMF 321 is responsible for registration management (e.g., for registering UE 301), connection management, reachability management, mobility management, and lawful interception of AMF-related events, and access authentication and authorization. The AMF 321 may be a termination point for the N11 reference point between the AMF 321 and the SMF 324. The AMF 321 may provide transport for SM messages between the UE 301 and the SMF 324, and act as a transparent pro10 for routing SM messages. AMF 321 may also provide transport for SMS messages between UE 301 and an SMSF (not shown in FIG. 3). AMF 321 may act as security anchor function (SEAF), which may include interaction with the AUSF 322 and the UE 301 to, for example, receive an intermediate key that was established as a result of the UE 301 authentication process. Where universal subscriber identity module (USIM) based authentication is used, the AMF 321 may retrieve the security material from the AUSF 322. AMF 321 may also include a security context management (SCM) function, which receives a key from the SEAF to derive access-network specific keys. Furthermore, AMF 321 may be a termination point of a RAN control plane interface, which may include or be a N2 reference point between the RAN 310 and the AMF 321. In some implementations, the AMF 321 may be a termination point of NAS (N1) signaling and perform NAS ciphering and integrity protection.

AMF 321 may also support NAS signaling with a UE 301 over a N3 interworking function (IWF) interface (referred to as the “N3IWF”). The N3IWF may be used to provide access to untrusted entities. The N3IWF may be a termination point for the N2 interface between the RAN 310 and the AMF 321 for the control plane, and may be a termination point for the N3 reference point between the RAN 310 and the UPF 302 for the user plane. As such, the AMF 321 may handle N2 signaling from the SMF 324 and the AMF 321 for PDU sessions and QoS, encapsulate/de-encapsulate packets for IPsec and N3 tunneling, mark N3 user-plane packets in the uplink, and enforce QoS corresponding to N3 packet marking taking into account QoS requirements associated with such marking received over N2. The N3IWF may also relay uplink and downlink control-plane NAS signaling between the UE 301 and AMF 321 using a N1 reference point between the UE 301 and the AMF 321, and relay uplink and downlink user-plane packets between the UE 301 and UPF 302. The N31WF also provides mechanisms for IPsec tunnel establishment with the UE 301. The AMF 321 may exhibit a Namf service-based interface, and may be a termination point for a N14 reference point between two AMFs 321 and a N17 reference point between the AMF 321 and a 5G equipment identity registry (EIR) (not shown in FIG. 3).

The UE 301 may register with the AMF 321 in order to receive network services. Registration management (RM) is used to register or deregister the UE 301 with the network (e.g., AMF 321), and establish a UE context in the network (e.g., AMF 321). The UE 301 may operate in a RM-REGISTERED state or an RM-DEREGISTERED state. In the RM DEREGISTERED state, the UE 301 is not registered with the network, and the UE context in AMF 321 holds no valid location or routing information for the UE 301 so the UE 301 is not reachable by the AMF 321. In the RM REGISTERED state, the UE 301 is registered with the network, and the UE context in AMF 321 may hold a valid location or routing information for the UE 301 so the UE 301 is reachable by the AMF 321. In the RM-REGISTERED state, the UE 301 may perform mobility Registration Update procedures, perform periodic Registration Update procedures triggered by expiration of the periodic update timer (e.g., to notify the network that the UE 301 is still active), and perform a Registration Update procedure to update UE capability information or to re-negotiate protocol parameters with the network, among others.

The AMF 321 may store one or more RM contexts for the UE 301, where each RM context is associated with a specific access to the network. The RM context may be, for example, a data structure or database object, among others, that indicates or stores a registration state per access type and the periodic update timer. The AMF 321 may also store a 5GC mobility management (MM) context that may be the same or similar to the (E)MM context discussed previously. In some implementations, the AMF 321 may store a coverage enhancement mode B Restriction parameter of the UE 301 in an associated MM context or RM context. The AMF 321 may also derive the value, when needed, from the UE's usage setting parameter already stored in the UE context (and/or MM/RM context).

Connection management (CM) may be used to establish and release a signaling connection between the UE 301 and the AMF 321 over the N1 interface. The signaling connection is used to enable NAS signaling exchange between the UE 301 and the CN 320, and includes both the signaling connection between the UE and the AN (e.g., RRC connection or UE-N31WF connection for non-3GPP access) and the N2 connection for the UE 301 between the AN (e.g., RAN 310) and the AMF 321. In some implementations, the UE 301 may operate in one of two CM modes: CM-IDLE mode or CM-CONNECTED mode. When the UE 301 is operating in the CM-IDLE mode, the UE 301 may have no NAS signaling connection established with the AMF 321 over the N1 interface, and there may be RAN 310 signaling connection (e.g., N2 or N3 connections, or both) for the UE 301. When the UE 301 is operating in the CM-CONNECTED mode, the UE 301 may have an established NAS signaling connection with the AMF 321 over the N1 interface, and there may be a RAN 310 signaling connection (e.g., N2 and/or N3 connections) for the UE 301. Establishment of a N2 connection between the RAN 310 and the AMF 321 may cause the UE 301 to transition from the CM-IDLE mode to the CM-CONNECTED mode, and the UE 301 may transition from the CM-CONNECTED mode to the CM-IDLE mode when N2 signaling between the RAN 310 and the AMF 321 is released.

The SMF 324 may be responsible for session management (SM), such as session establishment, modify and release, including tunnel maintain between UPF and AN node; UE IP address allocation and management (including optional authorization); selection and control of UP function; configuring traffic steering at the UPF to route traffic to proper destination; termination of interfaces toward policy control functions; controlling part of policy enforcement and QoS; lawful intercept (for SM events and interface to L1 system); termination of SM parts of NAS messages; downlink data notification; initiating AN specific SM information, sent using AMF over N2 to AN; and determining SSC mode of a session. SM may refer to management of a PDU session, and a PDU session (or “session”) may refer to a PDU connectivity service that provides or enables the exchange of PDUs between a UE 301 and a data network (DN) 303 identified by a Data Network Name (DNN). PDU sessions may be established upon UE 301 request, modified upon UE 301 and 5GC 320 request, and released upon UE 301 and 5GC 320 request using NAS SM signaling exchanged over the N1 reference point between the UE 301 and the SMF 324. Upon request from an application server, the 5GC 320 may trigger a specific application in the UE 301. In response to receipt of the trigger message, the UE 301 may pass the trigger message (or relevant parts/information of the trigger message) to one or more identified applications in the UE 301. The identified application(s) in the UE 301 may establish a PDU session to a specific DNN. The SMF 324 may check whether the UE 301 requests are compliant with user subscription information associated with the UE 301. In this regard, the SMF 324 may retrieve and/or request to receive update notifications on SMF 324 level subscription data from the UDM 327.

The SMF 324 may include some or all of the following roaming functionality: handling local enforcement to apply QoS service level agreements (SLAs) (e.g., in VPLMN); charging data collection and charging interface (e.g., in VPLMN); lawful intercept (e.g., in VPLMN for SM events and interface to L1 system); and support for interaction with external DN for transport of signaling for PDU session authorization/authentication by external DN. A N16 reference point between two SMFs 324 may be included in the system 300, which may be between another SMF 324 in a visited network and the SMF 324 in the home network in roaming scenarios. Additionally, the SMF 324 may exhibit the Nsmf service-based interface.

The NEF 323 may provide means for securely exposing the services and capabilities provided by 3GPP network functions for third party, internal exposure/re-exposure, Application Functions (e.g., AF 328), edge computing or fog computing systems, among others. In some implementations, the NEF 323 may authenticate, authorize, and/or throttle the AFs. The NEF 323 may also translate information exchanged with the AF 328 and information exchanged with internal network functions. For example, the NEF 323 may translate between an AF-Service-Identifier and an internal 5GC information. NEF 323 may also receive information from other network functions (NFs) based on exposed capabilities of other network functions. This information may be stored at the NEF 323 as structured data, or at a data storage NF using standardized interfaces. The stored information can then be re-exposed by the NEF 323 to other NFs and AFs, or used for other purposes such as analytics, or both. Additionally, the NEF 323 may exhibit a Nnef service-based interface.

The NRF 325 may support service discovery functions, receive NF discovery requests from NF instances, and provide the information of the discovered NF instances to the NF instances. NRF 325 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 325 may exhibit the Nnrf service-based interface.

The PCF 326 may provide policy rules to control plane function(s) to enforce them, and may also support unified policy framework to govern network behavior. The PCF 326 may also implement a front end to access subscription information relevant for policy decisions in a unified data repository (UDR) of the UDM 327. The PCF 326 may communicate with the AMF 321 using an N15 reference point between the PCF 326 and the AMF 321, which may include a PCF 326 in a visited network and the AMF 321 in case of roaming scenarios. The PCF 326 may communicate with the AF 328 using a N5 reference point between the PCF 326 and the AF 328; and with the SMF 324 using a N7 reference point between the PCF 326 and the SMF 324. The system 300 or CN 320, or both, may also include a N24 reference point between the PCF 326 (in the home network) and a PCF 326 in a visited network. Additionally, the PCF 326 may exhibit a Npcf service-based interface.

The UDM 327 may handle subscription-related information to support the network entities' handling of communication sessions, and may store subscription data of UE 301. For example, subscription data may be communicated between the UDM 327 and the AMF 321 using a N8 reference point between the UDM 327 and the AMF. The UDM 327 may include two parts, an application front end and a UDR (the front end and UDR are not shown in FIG. 3). The UDR may store subscription data and policy data for the UDM 327 and the PCF 326, or structured data for exposure and application data (including PFDs for application detection, application request information for multiple UEs 301) for the NEF 323, or both. The Nudr service-based interface may be exhibited by the UDR 221 to allow the UDM 327, PCF 326, and NEF 323 to access a particular set of the stored data, as well as to read, update (e.g., add, modify), delete, and subscribe to notification of relevant data changes in the UDR. The UDM may include a UDM front end, which is in charge of processing credentials, location management, subscription management and so on. Several different front ends may serve the same user in different transactions. The UDM front end accesses subscription information stored in the UDR and performs authentication credential processing, user identification handling, access authorization, registration/mobility management, and subscription management. The UDR may interact with the SMF 324 using a N10 reference point between the UDM 327 and the SMF 324. UDM 327 may also support SMS management, in which an SMS front end implements the similar application logic as discussed previously. Additionally, the UDM 327 may exhibit the Nudm service-based interface.

The AF 328 may provide application influence on traffic routing, provide access to the network capability exposure (NCE), and interact with the policy framework for policy control. The NCE may be a mechanism that allows the 5GC 320 and AF 328 to provide information to each other using NEF 323, which may be used for edge computing implementations. In such implementations, the network operator and third party services may be hosted close to the UE 301 access point of attachment to achieve an efficient service delivery through the reduced end-to-end latency and load on the transport network. For edge computing implementations, the 5GC may select a UPF 302 close to the UE 301 and execute traffic steering from the UPF 302 to DN 303 using the N6 interface. This may be based on the UE subscription data, UE location, and information provided by the AF 328. In this way, the AF 328 may influence UPF (re)selection and traffic routing. Based on operator deployment, when AF 328 is considered to be a trusted entity, the network operator may permit AF 328 to interact directly with relevant NFs. Additionally, the AF 328 may exhibit a Naf service-based interface.

The NSSF 329 may select a set of network slice instances serving the UE 301. The NSSF 329 may also determine allowed NSSAI and the mapping to the subscribed single network slice selection assistance information (S-NSSAI), if needed. The NSSF 329 may also determine the AMF set to be used to serve the UE 301, or a list of candidate AMF(s) 321 based on a suitable configuration and possibly by querying the NRF 325. The selection of a set of network slice instances for the UE 301 may be triggered by the AMF 321 with which the UE 301 is registered by interacting with the NSSF 329, which may lead to a change of AMF 321. The NSSF 329 may interact with the AMF 321 using an N22 reference point between AMF 321 and NSSF 329; and may communicate with another NSSF 329 in a visited network using a N31 reference point (not shown by FIG. 3). Additionally, the NSSF 329 may exhibit a Nnssf service-based interface.

As discussed previously, the CN 320 may include an SMSF, which may be responsible for SMS subscription checking and verification, and relaying SM messages to or from the UE 301 to or from other entities, such as an SMS-GMSC/IWMSC/SMS-router. The SMS may also interact with AMF 321 and UDM 327 for a notification procedure that the UE 301 is available for SMS transfer (e.g., set a UE not reachable flag, and notifying UDM 327 when UE 301 is available for SMS).

In some implementations, there may be additional or alternative reference points or service-based interfaces, or both, between the network function services in the network functions. However, these interfaces and reference points have been omitted from FIG. 3 for clarity. In one example, the CN 320 may include a Nx interface, which is an inter-CN interface between the MME (e.g., MME 221) and the AMF 321 in order to enable interworking between CN 320 and CN 220. Other example interfaces or reference points may include a N5g-EIR service-based interface exhibited by a 5G-EIR, a N27 reference point between the NRF in the visited network and the NRF in the home network, or a N31 reference point between the NSSF in the visited network and the NSSF in the home network, among others.

In some implementations, the components of the CN 220 may be implemented in one physical node or separate physical nodes and may include components to read and execute instructions from a machine-readable or computer-readable medium (e.g., a non-transitory machine-readable storage medium). In some implementations, the components of CN 320 may be implemented in a same or similar manner as discussed herein with regard to the components of CN 220. In some implementations, NFV is utilized to virtualize any or all of the above-described network node functions using executable instructions stored in one or more computer-readable storage mediums, as described in further detail below. A logical instantiation of the CN 220 may be referred to as a network slice, and individual logical instantiations of the CN 220 may provide specific network capabilities and network characteristics. A logical instantiation of a portion of the CN 220 may be referred to as a network sub-slice, which can include the P-GW 223 and the PCRF 226.

As used herein, the terms “instantiate,” “instantiation,” and the like may refer to the creation of an instance, and an “instance” may refer to a concrete occurrence of an object, which may occur, for example, during execution of program code. A network instance may refer to information identifying a domain, which may be used for traffic detection and routing in case of different IP domains or overlapping IP addresses. A network slice instance may refer to a set of network functions (NFs) instances and the resources (e.g., compute, storage, and networking resources) required to deploy the network slice.

With respect to 5G systems (see, e.g., FIG. 3), a network slice may include a RAN part and a CN part. The support of network slicing relies on the principle that traffic for different slices is handled by different PDU sessions. The network can realize the different network slices by scheduling or by providing different L1/L2 configurations, or both. The UE 301 provides assistance information for network slice selection in an appropriate RRC message if it has been provided by NAS. While the network can support large number of slices, the UE need not support more than 8 slices simultaneously in some implementations.

A network slice may include the CN 320 control plane and user plane NFs, NG-RANs 310 in a serving PLMN, and a N3IWF functions in the serving PLMN. Individual network slices may have different S-NSSAI or different SSTs, or both. NSSAI includes one or more S-NSSAIs, and each network slice is uniquely identified by an S-NSSAI. Network slices may differ for supported features and network functions optimizations. In some implementations, multiple network slice instances may deliver the same services or features but for different groups of UEs 301 (e.g., enterprise users). For example, individual network slices may deliver different committed service(s) or may be dedicated to a particular customer or enterprise, or both. In this example, each network slice may have different S-NSSAIs with the same SST but with different slice differentiators. Additionally, a single UE may be served with one or more network slice instances simultaneously using a 5G AN, and the UE may be associated with eight different S-NSSAIs. Moreover, an AMF 321 instance serving an individual UE 301 may belong to each of the network slice instances serving that UE.

Network slicing in the NG-RAN 310 involves RAN slice awareness. RAN slice awareness includes differentiated handling of traffic for different network slices, which have been pre-configured. Slice awareness in the NG-RAN 310 is introduced at the PDU session level by indicating the S-NSSAI corresponding to a PDU session in all signaling that includes PDU session resource information. How the NG-RAN 310 supports the slice enabling in terms of NG-RAN functions (e.g., the set of network functions that comprise each slice) is implementation dependent. The NG-RAN 310 selects the RAN part of the network slice using assistance information provided by the UE 301 or the 5GC 320, which unambiguously identifies one or more of the pre-configured network slices in the PLMN. The NG-RAN 310 also supports resource management and policy enforcement between slices as per SLAs. A single NG-RAN node may support multiple slices, and the NG-RAN 310 may also apply an appropriate RRM policy for the SLA in place to each supported slice. The NG-RAN 310 may also support QoS differentiation within a slice.

The NG-RAN 310 may also use the UE assistance information for the selection of an AMF 321 during an initial attach, if available. The NG-RAN 310 uses the assistance information for routing the initial NAS to an AMF 321. If the NG-RAN 310 is unable to select an AMF 321 using the assistance information, or the UE 301 does not provide any such information, the NG-RAN 310 sends the NAS signaling to a default AMF 321, which may be among a pool of AMFs 321. For subsequent accesses, the UE 301 provides a temp ID, which is assigned to the UE 301 by the 5GC 320, to enable the NG-RAN 310 to route the NAS message to the appropriate AMF 321 as long as the temp ID is valid. The NG-RAN 310 is aware of, and can reach, the AMF 321 that is associated with the temp ID. Otherwise, the method for initial attach applies.

The NG-RAN 310 supports resource isolation between slices. NG-RAN 310 resource isolation may be achieved by means of RRM policies and protection mechanisms that should avoid that shortage of shared resources if one slice breaks the service level agreement for another slice. In some implementations, it is possible to fully dedicate NG-RAN 310 resources to a certain slice. How NG-RAN 310 supports resource isolation is implementation dependent.

Some slices may be available only in part of the network. Awareness in the NG-RAN 310 of the slices supported in the cells of its neighbors may be beneficial for inter-frequency mobility in connected mode. The slice availability may not change within the UE's registration area. The NG-RAN 310 and the 5GC 320 are responsible to handle a service request for a slice that may or may not be available in a given area. Admission or rejection of access to a slice may depend on factors such as support for the slice, availability of resources, support of the requested service by NG-RAN 310.

The UE 301 may be associated with multiple network slices simultaneously. In case the UE 301 is associated with multiple slices simultaneously, only one signaling connection is maintained, and for intra-frequency cell reselection, the UE 301 tries to camp on the best cell. For inter-frequency cell reselection, dedicated priorities can be used to control the frequency on which the UE 301 camps. The 5GC 320 is to validate that the UE 301 has the rights to access a network slice. Prior to receiving an Initial Context Setup Request message, the NG-RAN 310 may be allowed to apply some provisional or local policies based on awareness of a particular slice that the UE 301 is requesting to access. During the initial context setup, the NG-RAN 310 is informed of the slice for which resources are being requested.

FIG. 4 illustrates an example of infrastructure equipment 400. The infrastructure equipment 400 (or “system 400”) may be implemented as a base station, a radio head, a RAN node, such as the RAN nodes 111 shown and described previously, an application server 130, or any other component or device described herein. In other examples, the system 400 can be implemented in or by a UE.

The system 400 includes application circuitry 405, baseband circuitry 410, one or more radio front end modules (RFEMs) 415, memory circuitry 420, power management integrated circuitry (PMIC) 425, power tee circuitry 430, network controller circuitry 435, network interface connector 440, satellite positioning circuitry 445, and user interface circuitry 450. In some implementations, the system 400 may include additional elements such as, for example, memory, storage, a display, a camera, one or more sensors, or an input/output (I/O) interface, or combinations of them, among others. In other examples, the components described with reference to the system 400 may be included in more than one device. For example, the various circuitries may be separately included in more than one device for CRAN, vBBU, or other implementations.

The application circuitry 405 includes circuitry such as, but not limited to, one or more processors (or processor cores), cache memory, one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD), MultiMediaCard (MMC), Universal Serial Bus (USB) interfaces, Mobile Industry Processor Interface (MIPI) interfaces and Joint Test Access Group (JTAG) test access ports. The processors (or cores) of the application circuitry 405 may be coupled with or may include memory or storage elements and may be configured to execute instructions stored in the memory or storage to enable various applications or operating systems to run on the system 400. In some implementations, the memory or storage elements may include on-chip memory circuitry, which may include any suitable volatile or non-volatile memory, such as DRAM, SRAM, EPROM, EEPROM, Flash memory, solid-state memory, or combinations of them, among other types of memory.

The processor(s) of the application circuitry 405 may include, for example, one or more processor cores (CPUs), one or more application processors, one or more graphics processing units (GPUs), one or more reduced instruction set computing (RISC) processors, one or more complex instruction set computing (CISC) processors, one or more digital signal processors (DSP), one or more FPGAs, one or more PLDs, one or more ASICs, one or more microprocessors or controllers, or combinations of them, among others. In some implementations, the application circuitry 405 may include, or may be, a special-purpose processor or controller configured to carry out the various techniques described here. In some implementations, the system 400 may not utilize application circuitry 405, and instead may include a special-purpose processor or controller to process IP data received from an EPC or 5GC, for example.

In some implementations, the application circuitry 405 may include one or more hardware accelerators, which may be microprocessors, programmable processing devices, or the like. The one or more hardware accelerators may include, for example, computer vision (CV) or deep learning (DL) accelerators, or both. In some implementations, the programmable processing devices may be one or more a field-programmable devices (FPDs) such as field-programmable gate arrays (FPGAs) and the like; programmable logic devices (PLDs) such as complex PLDs (CPLDs) or high-capacity PLDs (HCPLDs); ASICs such as structured ASICs; programmable SoCs (PSoCs), or combinations of them, among others. In such implementations, the circuitry of application circuitry 405 may include logic blocks or logic fabric, and other interconnected resources that may be programmed to perform various functions, such as the procedures, methods, functions described herein. In some implementations, the circuitry of application circuitry 405 may include memory cells (e.g., erasable programmable read-only memory (EPROM), electrically erasable programmable read-only memory (EEPROM), flash memory, static memory (e.g., static random access memory (SRAM) or anti-fuses)) used to store logic blocks, logic fabric, data, or other data in look-up-tables (LUTs) and the like.

The user interface circuitry 450 may include one or more user interfaces designed to enable user interaction with the system 400 or peripheral component interfaces designed to enable peripheral component interaction with the system 400. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, or combinations of them, among others. Peripheral component interfaces may include, but are not limited to, a nonvolatile memory port, a universal serial bus (USB) port, an audio jack, a power supply interface, among others.

The radio front end modules (RFEMs) 415 may include a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays, and the RFEM may be connected to multiple antennas. In some implementations, both mmWave and sub-mmWave radio functions may be implemented in the same physical RFEM 415, which incorporates both mmWave antennas and sub-mmWave. The baseband circuitry 410 may be implemented, for example, as a solder-down substrate including one or more integrated circuits, a single packaged integrated circuit soldered to a main circuit board or a multi-chip module containing two or more integrated circuits.

The memory circuitry 420 may include one or more of volatile memory, such as dynamic random access memory (DRAM) or synchronous dynamic random access memory (SDRAM), and nonvolatile memory (NVM), such as high-speed electrically erasable memory (commonly referred to as Flash memory), phase change random access memory (PRAM), or magnetoresistive random access memory (MRAM), or combinations of them, among others. Memory circuitry 420 may be implemented as one or more of solder down packaged integrated circuits, socketed memory modules and plug-in memory cards, for example.

The PMIC 425 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 430 may provide for electrical power drawn from a network cable to provide both power supply and data connectivity to the infrastructure equipment 400 using a single cable.

The network controller circuitry 435 may provide connectivity to a network using a standard network interface protocol such as Ethernet, Ethernet over GRE Tunnels, Ethernet over Multiprotocol Label Switching (MPLS), or some other suitable protocol. Network connectivity may be provided to and from the infrastructure equipment 400 using network interface connector 440 using a physical connection, which may be electrical (commonly referred to as a “copper interconnect”), optical, or wireless. The network controller circuitry 435 may include one or more dedicated processors or FPGAs, or both, to communicate using one or more of the aforementioned protocols. In some implementations, the network controller circuitry 435 may include multiple controllers to provide connectivity to other networks using the same or different protocols.

The positioning circuitry 445 includes circuitry to receive and decode signals transmitted or broadcasted by a positioning network of a global navigation satellite system (GNSS). Examples of a GNSS include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS)), among other systems. The positioning circuitry 445 can include various hardware elements (e.g., including hardware devices such as switches, filters, amplifiers, antenna elements, and the like to facilitate OTA communications) to communicate with components of a positioning network, such as navigation satellite constellation nodes. In some implementations, the positioning circuitry 445 may include a Micro-Technology for Positioning, Navigation, and Timing (Micro-PNT) IC that uses a master timing clock to perform position tracking and estimation without GNSS assistance. The positioning circuitry 445 may also be part of, or interact with, the baseband circuitry 410 or RFEMs 415, or both, to communicate with the nodes and components of the positioning network. The positioning circuitry 445 may also provide data (e.g., position data, time data) to the application circuitry 405, which may use the data to synchronize operations with various infrastructure (e.g., RAN nodes 111).

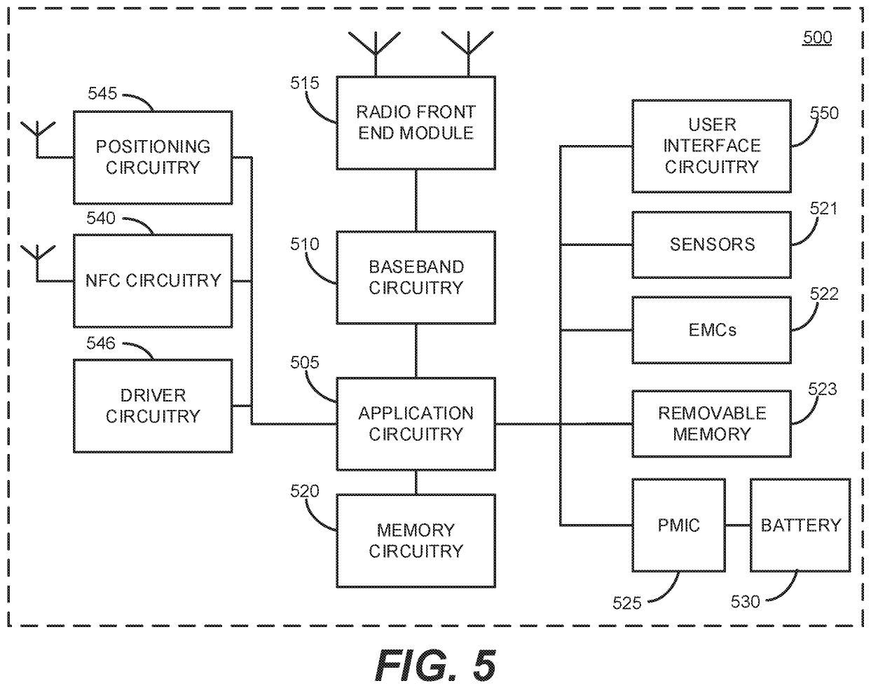

FIG. 5 illustrates an example of a platform 500 (or “device 500”). In some implementations, the computer platform 500 may be suitable for use as UEs 101, 201, 301, application servers 130, or any other component or device discussed herein. The platform 500 may include any combinations of the components shown in the example. The components of platform 500 (or portions thereof) may be implemented as integrated circuits (ICs), discrete electronic devices, or other modules, logic, hardware, software, firmware, or a combination of them adapted in the computer platform 500, or as components otherwise incorporated within a chassis of a larger system. The block diagram of FIG. 5 is intended to show a high level view of components of the platform 500. However, in some implementations, the platform 500 may include fewer, additional, or alternative components, or a different arrangement of the components shown in FIG. 5.

The application circuitry 505 includes circuitry such as, but not limited to, one or more processors (or processor cores), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 505 may be coupled with or may include memory/storage elements and may be configured to execute instructions stored in the memory or storage to enable various applications or operating systems to run on the system 500. In some implementations, the memory or storage elements may be on-chip memory circuitry, which may include any suitable volatile or non-volatile memory, such as DRAM, SRAM, EPROM, EEPROM, Flash memory, solid-state memory, or combinations of them, among other types of memory.

The processor(s) of application circuitry 505 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some implementations, the application circuitry 405 may include, or may be, a special-purpose processor/controller to carry out the techniques described herein. In some implementations, the application circuitry 505 may be a part of a system on a chip (SoC) in which the application circuitry 505 and other components are formed into a single integrated circuit, or a single package.

In some implementations, the application circuitry 505 may include circuitry such as, but not limited to, one or more a field-programmable devices (FPDs) such as FPGAs; PLDs such as CPLDs, HCPLDs; ASICs such as structured ASICs; PSoCs, or combinations of them, among others. In some implementations, the application circuitry 505 may include logic blocks or logic fabric, and other interconnected resources that may be programmed to perform various functions, such as the procedures, methods, functions described herein. In some implementations, the application circuitry 505 may include memory cells e.g., EPROM, EEPROM, flash memory, static memory such as SRAM or anti-fuses, used to store logic blocks, logic fabric, data, or other data in LUTs and the like.

The baseband circuitry 510 may be implemented, for example, as a solder-down substrate including one or more integrated circuits, a single packaged integrated circuit soldered to a main circuit board or a multi-chip module containing two or more integrated circuits.

The RFEMs 515 may comprise a millimeter wave (mmWave) RFEM and one or more sub-mmWave RFICs. In some implementations, the one or more sub-mmWave RFICs may be physically separated from the mmWave RFEM. The RFICs may include connections to one or more antennas or antenna arrays, and the RFEM may be connected to multiple antennas. In some implementations, both mmWave and sub-mmWave radio functions may be implemented in the same physical RFEM 515, which incorporates both mmWave antennas and sub-mmWave. In some implementations, the RFEMs 515, the baseband circuitry 510, or both are included in a transceiver of the platform 500.

The memory circuitry 520 may include any number and type of memory devices used to provide for a given amount of system memory. As examples, the memory circuitry 520 may include one or more of volatile memory, such as RAM, DRAM, or SDRAM, and NVM, such as high-speed electrically erasable memory (commonly referred to as Flash memory), PRAM, or MRAM, or combinations of them, among others. In low power implementations, the memory circuitry 520 may be on-die memory or registers associated with the application circuitry 505. To provide for persistent storage of information such as data, applications, operating systems and so forth, memory circuitry 520 may include one or more mass storage devices, which may include, for example, a solid state drive (SSD), hard disk drive (HDD), a micro HDD, resistance change memories, phase change memories, holographic memories, or chemical memories, among others.

The removable memory circuitry 523 may include devices, circuitry, enclosures, housings, ports or receptacles, among others, used to couple portable data storage devices with the platform 500. These portable data storage devices may be used for mass storage purposes, and may include, for example, flash memory cards (e.g., Secure Digital (SD) cards, microSD cards, xD picture cards), and USB flash drives, optical discs, or external HDDs, or combinations of them, among others. The platform 500 may also include interface circuitry (not shown) for connecting external devices with the platform 500. The external devices connected to the platform 500 using the interface circuitry include sensor circuitry 521 and electro-mechanical components (EMCs) 522, as well as removable memory devices coupled to removable memory circuitry 523.

The sensor circuitry 521 include devices, modules, or subsystems whose purpose is to detect events or changes in its environment and send the information (e.g., sensor data) about the detected events to one or more other devices, modules, or subsystems. Examples of such sensors include inertial measurement units (IMUs) such as accelerometers, gyroscopes, or magnetometers; microelectromechanical systems (MEMS) or nanoelectromechanical systems (NEMS) including 3-axis accelerometers, 3-axis gyroscopes, or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other audio capture devices, or combinations of them, among others.

The EMCs 522 include devices, modules, or subsystems whose purpose is to enable the platform 500 to change its state, position, or orientation, or move or control a mechanism, system, or subsystem. Additionally, the EMCs 522 may be configured to generate and send messages or signaling to other components of the platform 500 to indicate a current state of the EMCs 522. Examples of the EMCs 522 include one or more power switches, relays, such as electromechanical relays (EMRs) or solid state relays (SSRs), actuators (e.g., valve actuators), an audible sound generator, a visual warning device, motors (e.g., DC motors or stepper motors), wheels, thrusters, propellers, claws, clamps, hooks, or combinations of them, among other electro-mechanical components. In some implementations, the platform 500 is configured to operate one or more EMCs 522 based on one or more captured events, instructions, or control signals received from a service provider or clients, or both.

In some implementations, the interface circuitry may connect the platform 500 with positioning circuitry 545. The positioning circuitry 545 includes circuitry to receive and decode signals transmitted or broadcasted by a positioning network of a GNSS. The positioning circuitry 545 comprises various hardware elements (e.g., including hardware devices such as switches, filters, amplifiers, antenna elements, and the like to facilitate OTA communications) to communicate with components of a positioning network, such as navigation satellite constellation nodes. In some implementations, the positioning circuitry 545 may include a Micro-PNT IC that uses a master timing clock to perform position tracking or estimation without GNSS assistance. The positioning circuitry 545 may also be part of, or interact with, the baseband circuitry 510 or RFEMs 515, or both, to communicate with the nodes and components of the positioning network. The positioning circuitry 545 may also provide data (e.g., position data, time data) to the application circuitry 505, which may use the data to synchronize operations with various infrastructure (e.g., radio base stations), for turn-by-turn navigation applications, or the like.

In some implementations, the interface circuitry may connect the platform 500 with Near-Field Communication (NFC) circuitry 540. The NFC circuitry 540 is configured to provide contactless, short-range communications based on radio frequency identification (RFID) standards, in which magnetic field induction is used to enable communication between NFC circuitry 540 and NFC-enabled devices external to the platform 500 (e.g., an “NFC touchpoint”). The NFC circuitry 540 includes an NFC controller coupled with an antenna element and a processor coupled with the NFC controller. The NFC controller may be a chip or IC providing NFC functionalities to the NFC circuitry 540 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 540, or initiate data transfer between the NFC circuitry 540 and another active NFC device (e.g., a smartphone or an NFC-enabled POS terminal) that is proximate to the platform 500.

The driver circuitry 546 may include software and hardware elements that operate to control particular devices that are embedded in the platform 500, attached to the platform 500, or otherwise communicatively coupled with the platform 500. The driver circuitry 546 may include individual drivers allowing other components of the platform 500 to interact with or control various input/output (I/O) devices that may be present within, or connected to, the platform 500. For example, the driver circuitry 546 may include a display driver to control and allow access to a display device, a touchscreen driver to control and allow access to a touchscreen interface of the platform 500, sensor drivers to obtain sensor readings of sensor circuitry 521 and control and allow access to sensor circuitry 521, EMC drivers to obtain actuator positions of the EMCs 522 or control and allow access to the EMCs 522, a camera driver to control and allow access to an embedded image capture device, audio drivers to control and allow access to one or more audio devices.

The power management integrated circuitry (PMIC) 525 (also referred to as “power management circuitry 525”) may manage power provided to various components of the platform 500. In particular, with respect to the baseband circuitry 510, the PMIC 525 may control power-source selection, voltage scaling, battery charging, or DC-to-DC conversion. The PM IC 525 may be included when the platform 500 is capable of being powered by a battery 530, for example, when the device is included in a UE 101, 201, 301.

In some implementations, the PMIC 525 may control, or otherwise be part of, various power saving mechanisms of the platform 500. For example, if the platform 500 is in an RRC_CONNECTED state, where it is still connected to the RAN node as it expects to receive traffic shortly, then it may enter a state known as Discontinuous Reception Mode (DRX) after a period of inactivity. During this state, the platform 500 may power down for brief intervals of time and thus save power. If there is no data traffic activity for an extended period of time, then the platform 500 may transition off to an RRC_IDLE state, where it disconnects from the network and does not perform operations such as channel quality feedback or handover. This can allow the platform 500 to enter a very low power state, where it periodically wakes up to listen to the network and then powers down again. In some implementations, the platform 500 may not receive data in the RRC_IDLE state and instead must transition back to RRC_CONNECTED state to receive data. An additional power saving mode may allow a device to be unavailable to the network for periods longer than a paging interval (ranging from seconds to a few hours). During this time, the device may be unreachable to the network and may power down completely. Any data sent during this time may incurs a large delay and it is assumed the delay is acceptable.

A battery 530 may power the platform 500, although in some implementations the platform 500 may be deployed in a fixed location, and may have a power supply coupled to an electrical grid. The battery 530 may be a lithium ion battery, a metal-air battery, such as a zinc-air battery, an aluminum-air battery, or a lithium-air battery, among others. In some implementations, such as in V2X applications, the battery 530 may be a typical lead-acid automotive battery.

The user interface circuitry 550 includes various input/output (I/O) devices present within, or connected to, the platform 500, and includes one or more user interfaces designed to enable user interaction with the platform 500 or peripheral component interfaces designed to enable peripheral component interaction with the platform 500. The user interface circuitry 550 includes input device circuitry and output device circuitry. Input device circuitry includes any physical or virtual means for accepting an input including one or more physical or virtual buttons (e.g., a reset button), a physical keyboard, keypad, mouse, touchpad, touchscreen, microphones, scanner, or headset, or combinations of them, among others. The output device circuitry includes any physical or virtual means for showing information or otherwise conveying information, such as sensor readings, actuator position(s), or other information. Output device circuitry may include any number or combinations of audio or visual display, including one or more simple visual outputs or indicators (e.g., binary status indicators (e.g., light emitting diodes (LEDs)), multi-character visual outputs, or more complex outputs such as display devices or touchscreens (e.g., Liquid Crystal Displays (LCD), LED displays, quantum dot displays, or projectors), with the output of characters, graphics, or multimedia objects being generated or produced from the operation of the platform 500. The output device circuitry may also include speakers or other audio emitting devices, or printer(s). In some implementations, the sensor circuitry 521 may be used as the input device circuitry (e.g., an image capture device or motion capture device), and one or more EMCs may be used as the output device circuitry (e.g., an actuator to provide haptic feedback). In another example, NFC circuitry comprising an NFC controller coupled with an antenna element and a processing device may be included to read electronic tags or connect with another NFC-enabled device. Peripheral component interfaces may include, but are not limited to, a non-volatile memory port, a USB port, an audio jack, or a power supply interface.

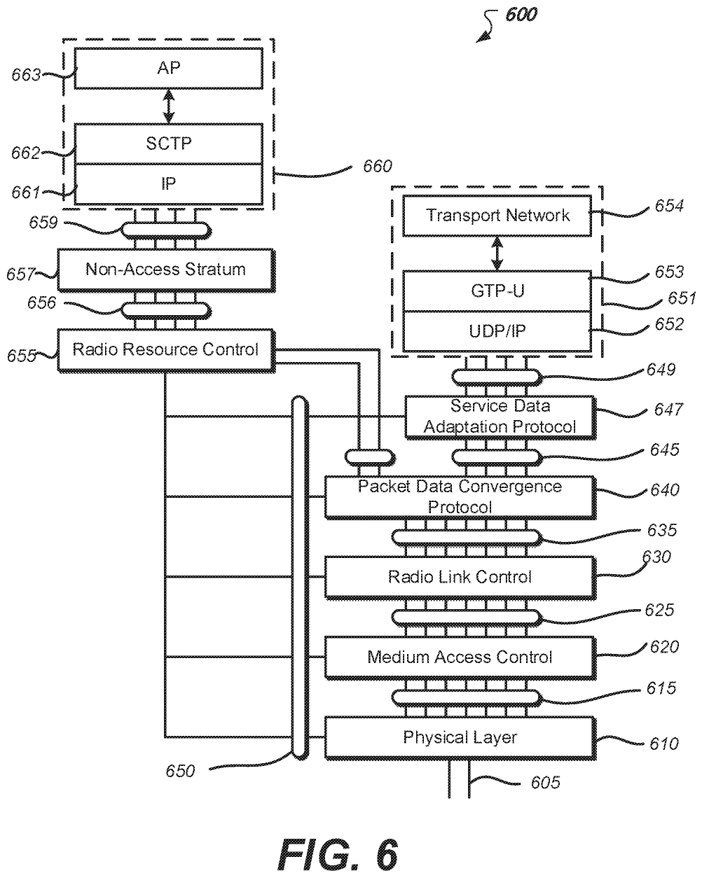

FIG. 6 illustrates various protocol functions that may be implemented in a wireless communication device. In particular, FIG. 6 includes an arrangement 600 showing interconnections between various protocol layers/entities. The following description of FIG. 6 is provided for various protocol layers and entities that operate in conjunction with the 5G NR system standards and the LTE system standards, but some or all of the aspects of FIG. 6 may be applicable to other wireless communication network systems as well.

The protocol layers of arrangement 600 may include one or more of PHY 610, MAC 620, RLC 630, PDCP 640, SDAP 647, RRC 655, and NAS layer 657, in addition to other higher layer functions not illustrated. The protocol layers may include one or more service access points (e.g., items 659, 656, 650, 649, 645, 635, 625, and 615 in FIG. 6) that may provide communication between two or more protocol layers.

The PHY 610 may transmit and receive physical layer signals 605 that may be received from or transmitted to one or more other communication devices. The physical layer signals 605 may include one or more physical channels, such as those discussed herein. The PHY 610 may further perform link adaptation or adaptive modulation and coding (AMC), power control, cell search (e.g., for initial synchronization and handover purposes), and other measurements used by higher layers, such as the RRC 655. The PHY 610 may still further perform error detection on the transport channels, forward error correction (FEC) coding and decoding of the transport channels, modulation and demodulation of physical channels, interleaving, rate matching, mapping onto physical channels, and MIMO antenna processing. In some implementations, an instance of PHY 610 may process requests from and provide indications to an instance of MAC 620 using one or more PHY-SAP 615. In some implementations, requests and indications communicated using PHY-SAP 615 may comprise one or more transport channels.

Instance(s) of MAC 620 may process requests from, and provide indications to, an instance of RLC 630 using one or more MAC-SAPs 625. These requests and indications communicated using the MAC-SAP 625 may include one or more logical channels. The MAC 620 may perform mapping between the logical channels and transport channels, multiplexing of MAC SDUs from one or more logical channels onto transport blocks (TBs) to be delivered to PHY 610 using the transport channels, de-multiplexing MAC SDUs to one or more logical channels from TBs delivered from the PHY 610 using transport channels, multiplexing MAC SDUs onto TBs, scheduling information reporting, error correction through HARQ, and logical channel prioritization.

Instance(s) of RLC 630 may process requests from and provide indications to an instance of PDCP 640 using one or more radio link control service access points (RLC-SAP) 635. These requests and indications communicated using RLC-SAP 635 may include one or more RLC channels. The RLC 630 may operate in a plurality of modes of operation, including: Transparent Mode (TM), Unacknowledged Mode (UM), and Acknowledged Mode (AM). The RLC 630 may execute transfer of upper layer protocol data units (PDUs), error correction through automatic repeat request (ARQ) for AM data transfers, and concatenation, segmentation and reassembly of RLC SDUs for UM and AM data transfers. The RLC 630 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

Instance(s) of PDCP 640 may process requests from and provide indications to instance(s) of RRC 655 or instance(s) of SDAP 647, or both, using one or more packet data convergence protocol service access points (PDCP-SAP) 645. These requests and indications communicated using PDCP-SAP 645 may include one or more radio bearers. The PDCP 640 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, or integrity verification).

Instance(s) of SDAP 647 may process requests from and provide indications to one or more higher layer protocol entities using one or more SDAP-SAP 649. These requests and indications communicated using SDAP-SAP 649 may include one or more QoS flows. The SDAP 647 may map QoS flows to data radio bearers (DRBs), and vice versa, and may also mark QoS flow identifiers (QFIs) in DL and UL packets. A single SDAP entity 647 may be configured for an individual PDU session. In the UL direction, the NG-RAN 110 may control the mapping of QoS Flows to DRB(s) in two different ways, reflective mapping or explicit mapping. For reflective mapping, the SDAP 647 of a UE 101 may monitor the QFIs of the DL packets for each DRB, and may apply the same mapping for packets flowing in the UL direction. For a DRB, the SDAP 647 of the UE 101 may map the UL packets belonging to the QoS flows(s) corresponding to the QoS flow ID(s) and PDU session observed in the DL packets for that DRB. To enable reflective mapping, the NG-RAN 310 may mark DL packets over the Uu interface with a QoS flow ID. The explicit mapping may involve the RRC 655 configuring the SDAP 647 with an explicit QoS flow to DRB mapping rule, which may be stored and followed by the SDAP 647. In some implementations, the SDAP 647 may only be used in NR implementations and may not be used in LTE implementations.

The RRC 655 may configure, using one or more management service access points (M-SAP), aspects of one or more protocol layers, which may include one or more instances of PHY 610, MAC 620, RLC 630, PDCP 640 and SDAP 647. In some implementations, an instance of RRC 655 may process requests from and provide indications to one or more NAS entities 657 using one or more RRC-SAPs 656. The main services and functions of the RRC 655 may include broadcast of system information (e.g., included in master information blocks (MIBs) or system information blocks (SIBs) related to the NAS), broadcast of system information related to the access stratum (AS), paging, establishment, maintenance and release of an RRC connection between the UE 101 and RAN 110 (e.g., RRC connection paging, RRC connection establishment, RRC connection modification, and RRC connection release), establishment, configuration, maintenance and release of point to point Radio Bearers, security functions including key management, inter-RAT mobility, and measurement configuration for UE measurement reporting. The MIBs and SIBs may comprise one or more information elements (IEs), which may each comprise individual data fields or data structures. The NAS 657 may form the highest stratum of the control plane between the UE 101 and the AMF 321. The NAS 657 may support the mobility of the UEs 101 and the session management procedures to establish and maintain IP connectivity between the UE 101 and a P-GW in LTE systems.

In some implementations, one or more protocol entities of arrangement 600 may be implemented in UEs 101, RAN nodes 111, AMF 321 in NR implementations or MME 221 in LTE implementations, UPF 302 in NR implementations or S-GW 222 and P-GW 223 in LTE implementations, or the like to be used for control plane or user plane communications protocol stack between the aforementioned devices. In some implementations, one or more protocol entities that may be implemented in one or more of UE 101, gNB 111, AMF 321, among others, may communicate with a respective peer protocol entity that may be implemented in or on another device using the services of respective lower layer protocol entities to perform such communication. In some implementations, a gNB-CU of the gNB 111 may host the RRC 655, SDAP 647, and PDCP 640 of the gNB that controls the operation of one or more gNB-DUs, and the gNB-DUs of the gNB 111 may each host the RLC 630, MAC 620, and PHY 610 of the gNB 111.

In some implementations, a control plane protocol stack may include, in order from highest layer to lowest layer, NAS 657, RRC 655, PDCP 640, RLC 630, MAC 620, and PHY 610. In this example, upper layers 660 may be built on top of the NAS 657, which includes an IP layer 661, an SCTP 662, and an application layer signaling protocol (AP) 663.

In some implementations, such as NR implementations, the AP 663 may be an NG application protocol layer (NGAP or NG-AP) 663 for the NG interface 113 defined between the NG-RAN node 111 and the AMF 321, or the AP 663 may be an Xn application protocol layer (XnAP or Xn-AP) 663 for the Xn interface 112 that is defined between two or more RAN nodes 111. The NG-AP 663 may support the functions of the NG interface 113 and may comprise elementary procedures (EPs). An NG-AP EP may be a unit of interaction between the NG-RAN node 111 and the AMF 321. The NG-AP 663 services may include two groups: UE-associated services (e.g., services related to a UE 101) and non-UE-associated services (e.g., services related to the whole NG interface instance between the NG-RAN node 111 and AMF 321). These services may include functions such as, but not limited to: a paging function for the sending of paging requests to NG-RAN nodes 111 involved in a particular paging area; a UE context management function for allowing the AMF 321 to establish, modify, or release a UE context in the AMF 321 and the NG-RAN node 111; a mobility function for UEs 101 in ECM-CONNECTED mode for intra-system HOs to support mobility within NG-RAN and inter-system HOs to support mobility from/to EPS systems; a NAS Signaling Transport function for transporting or rerouting NAS messages between UE 101 and AMF 321; a NAS node selection function for determining an association between the AMF 321 and the UE 101; NG interface management function(s) for setting up the NG interface and monitoring for errors over the NG interface; a warning message transmission function for providing means to transfer warning messages using NG interface or cancel ongoing broadcast of warning messages; a configuration transfer function for requesting and transferring of RAN configuration information (e.g., SON information or performance measurement (PM) data) between two RAN nodes 111 using CN 120, or combinations of them, among others.

The XnAP 663 may support the functions of the Xn interface 112 and may comprise XnAP basic mobility procedures and XnAP global procedures. The XnAP basic mobility procedures may comprise procedures used to handle UE mobility within the NG RAN 111 (or E-UTRAN 210), such as handover preparation and cancellation procedures, SN Status Transfer procedures, UE context retrieval and UE context release procedures, RAN paging procedures, or dual connectivity related procedures, among others. The XnAP global procedures may comprise procedures that are not related to a specific UE 101, such as Xn interface setup and reset procedures, NG-RAN update procedures, or cell activation procedures, among others.

In LTE implementations, the AP 663 may bean S1 Application Protocol layer (S1-AP) 663 for the S1 interface 113 defined between an E-UTRAN node 111 and an MME, or the AP 663 may be an X2 application protocol layer (X2AP or X2-AP) 663 for the X2 interface 112 that is defined between two or more E-UTRAN nodes 111.

The S1 Application Protocol layer (S1-AP) 663 may support the functions of the S1 interface, and similar to the NG-AP discussed previously, the S1-AP may include S1-AP EPs. An S1-AP EP may be a unit of interaction between the E-UTRAN node 111 and an MME 221 within a LTE CN 120. The S1-AP 663 services may comprise two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The X2AP 663 may support the functions of the X2 interface 112 and may include X2AP basic mobility procedures and X2AP global procedures. The X2AP basic mobility procedures may include procedures used to handle UE mobility within the E-UTRAN 120, such as handover preparation and cancellation procedures, SN Status Transfer procedures, UE context retrieval and UE context release procedures, RAN paging procedures, or dual connectivity related procedures, among others. The X2AP global procedures may comprise procedures that are not related to a specific UE 101, such as X2 interface setup and reset procedures, load indication procedures, error indication procedures, or cell activation procedures, among others.

The SCTP layer (alternatively referred to as the SCTP/IP layer) 662 may provide guaranteed delivery of application layer messages (e.g., NGAP or XnAP messages in NR implementations, or S1-AP or X2AP messages in LTE implementations). The SCTP 662 may ensure reliable delivery of signaling messages between the RAN node 111 and the AMF 321/MME 221 based in part on the IP protocol, supported by the IP 661. The Internet Protocol layer (IP) 661 may be used to perform packet addressing and routing functionality. In some implementations the IP layer 661 may use point-to-point transmission to deliver and convey PDUs. In this regard, the RAN node 111 may include L2 and L1 layer communication links (e.g., wired or wireless) with the MME/AMF to exchange information.

In some implementations, a user plane protocol stack may include, in order from highest layer to lowest layer, SDAP 647, PDCP 640, RLC 630, MAC 620, and PHY 610. The user plane protocol stack may be used for communication between the UE 101, the RAN node 111, and UPF 302 in NR implementations or an S-GW 222 and P-GW 223 in LTE implementations. In this example, upper layers 651 may be built on top of the SDAP 647, and may include a user datagram protocol (UDP) and IP security layer (UDP/IP) 652, a General Packet Radio Service (GPRS) Tunneling Protocol for the user plane layer (GTP-U) 653, and a User Plane PDU layer (UP PDU) 663.

The transport network layer 654 (also referred to as a “transport layer”) may be built on IP transport, and the GTP-U 653 may be used on top of the UDP/IP layer 652 (comprising a UDP layer and IP layer) to carry user plane PDUs (UP-PDUs). The IP layer (also referred to as the “Internet layer”) may be used to perform packet addressing and routing functionality. The IP layer may assign IP addresses to user data packets in any of IPv4, IPv6, or PPP formats, for example.

The GTP-U 653 may be used for carrying user data within the GPRS core network and between the radio access network and the core network. The user data transported can be packets in any of IPv4, IPv6, or PPP formats, for example. The UDP/IP 652 may provide checksums for data integrity, port numbers for addressing different functions at the source and destination, and encryption and authentication on the selected data flows. The RAN node 111 and the S-GW 222 may utilize an S1-U interface to exchange user plane data using a protocol stack comprising an L1 layer (e.g., PHY 610), an L2 layer (e.g., MAC 620, RLC 630, PDCP 640, and/or SDAP 647), the UDP/IP layer 652, and the GTP-U 653. The S-GW 222 and the P-GW 223 may utilize an S5/S8a interface to exchange user plane data using a protocol stack comprising an L1 layer, an L2 layer, the UDP/IP layer 652, and the GTP-U 653. As discussed previously, NAS protocols may support the mobility of the UE 101 and the session management procedures to establish and maintain IP connectivity between the UE 101 and the P-GW 223.

Moreover, although not shown by FIG. 6, an application layer may be present above the AP 663 and/or the transport network layer 654. The application layer may be a layer in which a user of the UE 101, RAN node 111, or other network element interacts with software applications being executed, for example, by application circuitry 405 or application circuitry 505, respectively. The application layer may also provide one or more interfaces for software applications to interact with communications systems of the UE 101 or RAN node 111, such as the baseband circuitry 610. In some implementations, the IP layer or the application layer, or both, may provide the same or similar functionality as layers 5-7, or portions thereof, of the Open Systems Interconnection (OSI) model (e.g., OSI Layer 7—the application layer, OSI Layer 6—the presentation layer, and OSI Layer 5—the session layer).

The management of neighbor cell relations among base stations to support handovers can be a labor-intensive task if performed manually. The task can be further complicated by the addition of new RATs in a wireless network. Due to the size of radio networks with several hundred thousands of neighbor relations for a single operator, it can be a labor-intensive task to maintain the neighbor relations manually. ANR management can be used to automatically create and update the neighbor relations. This can generate efficiencies in resource utilization for mobile operators, and can reduce operating expenses via automation. The ANR function can be based on a self-organizing network (SON), which can be a distributed SON, centralized SON, or a combination of both.

5G NR networks can be denser than previous generations of mobile networks, as they contain macro cells in sub-6 Ghz bands to provide the coverage, while mixed with small cells in higher frequency, e.g., mmWave, bands in areas that require high capacity, in order to meet the future growth of mobile data traffic. During the off-peak hours, many high capacity cells can be switched off due to energy saving, which can increase the frequency of relation changes. ANR functionality can be used to change relations automatically.

Each gNB in a network can be assigned a PCI that is broadcast in synchronization signals such as primary synchronization signal (PSS) and secondary synchronization signal (SSS). When a UE receives PSS and SSS to acquire time and frequency synchronization, it also obtains the PCI that is used to uniquely identify a NR cell. In some implementations, there are 1,008 unique PCIs (see, e.g., clause 7.4.2 in TS 38.211). A substantial number of NR cells and small cells operating in millimeter wave bands are and will be deployed, PCIs may need to be reused. Typically, operators use network planning tool to assign PCIs to cells when the network is deployed to insure all neighboring cells have different PCIs. However, due to the addition of new cells or changes of neighbor relations from ANR functions, problems can arise, such as PCI collision and PCI confusion. In a PCI collision, two neighboring cells have the same PCIs. A PCI collision can be referred to as a PCI conflict. In PCI confusion, a cell has two neighboring cells with the same PCI value, where Cell #A has a PCI that is different from the PCIs of its two neighbors—Cell #B and Cell #C, but Cell #B and Cell #C have the same PCI. PCI confusion can impact the handover performance as UEs are confused with which cell they should handover to. PCI confusion can be viewed as a PCI collision among neighboring cells. The PCI can be configured by different configuration techniques such as a centralized PCI configuration or a distributed PCI configuration (see, e.g., clause 5.2.1 in TR 37.816).

This disclosure provides, among other things, techniques for RACH optimization and ANR to automatically configure RACH parameters and neighbor relations for wireless networks such as NR networks. One of more of these techniques can generate savings in resource utilization for mobile operators. In some implementations, ANR optimization can be initiated periodically as preventive maintenance. In some implementations, ANR optimization can be initiated based on detecting that the performance of a NR cell is degrading. ANR optimization can automatically update the neighbor cell relation table to generate increased savings in resource utilization for mobile operators. In some implementations, the PCI configuration in a SON is to automatically configure the PCIs of NR cells which are newly deployed and to reconfigure the PCIs of NR cells due to issues such as PCI collision or confusion to minimize manual operation from operators. This disclosure describes examples of use cases for a distributed ANR function, centralized ANR optimization, distributed PCI configuration function, and centralized PCI configuration optimization.

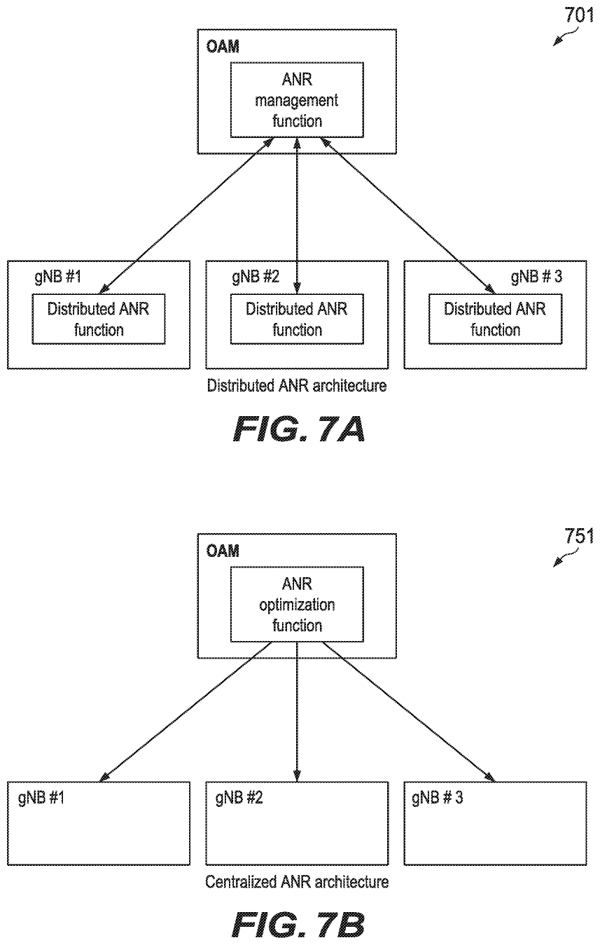

FIGS. 7A and 7B illustrate diagrams of different examples of ANR architectures. ANR functions can be deployed in a centralized SON (C-SON) or a distributed SON (D-SON) (see, e.g., 3GPP TS 32.511 and TS 38.300). ANR management can include automatic Xn setup, automatic X2 setup, or both.

FIG. 7A illustrates a diagram of an example of a distributed ANR architecture 701 for a D-SON. In a D-SON, a distributed ANR function can be deployed in the gNB of each NR cell, and the operation and maintenance (OAM) system can provide an ANR management function. Note that a gNB can control one or more cells. The ANR management function enables the distributed ANR function. In some implementations, the distributed ANR function is based on the procedure described in clause 15.3.3 of 3GPP TS 38.300. The distributed ANR function can detect a new inter or intra neighbor cell relation, and can add such a relation to the neighbor cell relation table. The distributed ANR function can detect when an existing inter or intra neighbor cell relation has been removed, and can delete such a relation from the neighbor cell relation table. The distributed ANR function can notify the ANR management function about the changes of neighbor cell relation in this NR cell. The ANR management function can set the blacklists and whitelists of neighbor cell relations, or change the attributes of a neighbor cell relation.

FIG. 7B illustrates a diagram of an example of a centralized ANR architecture 751 for a C-SON. In a C-SON, a centralized ANR optimization function can be deployed in the OAM system. ANR optimizations can include optimizations to the neighbor relations configured at one or more nodes such as NG-RAN nodes. Some wireless networks such as 5G NR networks can be much denser than previous generations of mobile networks, as they contain macro cells in sub-6 Ghz bands to provide the coverage, while mixed with small cells in higher frequency (e.g., mmWave) bands in areas that require high capacity, to meet the growth of mobile data traffic. During off-peak hours, many high capacity cells can be switched off or enter a sleep mode to save energy. This can increase the frequency of relation changes. In some implementations, a substantial number of neighbor cell relations and the nature of dynamic changes in relations may create increased load. Such load can be handled by a centralized ANR architecture.

In a wireless network, the NG-RAN and the provider(s) of a NG-RAN provisioning management service and NG-RAN performance measurement service can be deployed and active. The ANR optimization function can be a consumer of a NG-RAN provisioning management service. The function can subscribe to performance measurements related to mobility and interference management. As such, the function can receive performance measurements from gNBs. In some implementations, the gNBs can collect performance measurements from UEs and forward the measurements to the function. The measurements can include performance indicators such as statistics of failed or dropped RRC connections, handover failures, etc. Other types of measurements are possible.

The ANR optimization function can collect and monitor the statistics of UE measurement results that can be generated from the MeasResultListNR for intra-RAT neighbor relations, or MeasResultLisWEUTRA for inter-RAT neighbor relations (see, e.g., clause 6.3.2 in TS 38.331). When the ANR optimization function detects changes in some cells and can determine the appropriate actions to take such as create, modify, or delete neighbor relations in such cells and/or in some of the neighbor cells. The ANR optimization function can monitor the ANR performance (e.g., failed or dropped RRC connections, handover failures, etc.) of the cells managed by the provider(s) of NG-RAN provisioning and PM management services, and can continue the ANR optimization function, if it is detected that the ANR performance is degrading. In some implementations, ANR optimization for a cell can cease when the cell is taken out of service or when the ANR optimization function is stopped.

An ANR management function can, in some implementations, enable or disable one or more ANR functions. In some implementations, the ANR management function can set the blacklists and/or whitelists of neighbor cell relations, or modify the attributes of a neighbor cell relation. In some implementations, the ANR function can notify the ANR management function about the changes in a neighbor cell relation.

ANR related functions and other functions can use an Information Object Class (IOC), which can represent a management aspect of a network resource and can describe information that can be passed or used in one or more management interfaces. An IOC can have one or more attributes that represent various properties of the class of objects. An IOC can support operations providing network management services and can support notifications that report event occurrences relevant for that class of objects. In some implementations, ANR related functions and other functions can further use a Managed Object Instance (MOI). In some implementations, a MOI representation can be a technology specific software object, such as a 5G NR object. A MOI can have attributes that represents various properties of the class of objects. A MOI can support operations providing network management services and can support notifications that report event occurrences relevant for that class of objects.

A wireless network, as described above, can use distributed ANR management (D-ANR). In some implementations, an ANR management function can consume a management service for network function (NF) provisioning with a modify MOI attributes (e.g., modifyMOIAttributes) operation to enable the ANR function on a NR cell (see, e.g., clause 6.3 in 3GPP TS 28.531, and clause 5.1.3 in TS 28.532). In some implementations, consuming a service can also be referred to as using a service. The distributed ANR function can implement one of the following operations when a relevant event is detected: add a new relation to the neighbor cell relation table, when it detects a new inter or intra neighbor cell relation, or delete an existing relation from the neighbor cell relation table, when it detects such inter or intra neighbor cell relation has been removed.

The distributed ANR function can use the management service for NF provisioning to send one of the following notifications: notifyMOICreation to notify the ANR management function that a new neighbor cell relation has been added to the table or notifyMOIDeletion to notify the ANR management function that an existing neighbor cell relation has been removed from the table (see, e.g., 3GPP TS 28.532). The ANR management function can consume the management service for NF provisioning with operation modifyMOIAttributes to modify one or more ANR attributes such as handover (HO) attribute or a relation-removal-allowed attribute. The ANR management function can consume the management service for NF provisioning with operation createMOI to add a whitelist or blacklist to the neighbor cell relation table (see, e.g., clause 5.1.1 in 3GPP TS 28.532). In some implementations, an IOC NRCellRelation can include attributes to support ANR such as isRemoveAllowed, isHOAllowed, and others. (see, e.g., clause 4.3.32 in TS 28.541).

A wireless network, as described above, can use centralized ANR management (C-ANR). It can be assumed that the ANR optimization function has consumed a management service to collect performance measurements related to ANR optimization. The ANR optimization function can be initiated periodically as a preventive maintenance, or when it is detected that NR cells have been experiencing performance issues (e.g., a high number of failed and/or dropped RRC connections, handover failures, etc.). In some implementations, an ANR optimization function can coordinate with a distributed ANR function before updating the neighbor cell relation table.

The ANR optimization function can collect the performance measurements for neighbor cells and neighbor candidate cells of a given cell. Such measurements can include reference signal received power (RSRP) measurement results that can be generated from the MeasResultListNR for intra-RAT neighbor relations, or MeasResultListEUTRA for inter-RAT neighbor relations (see, e.g., clause 6.3.2 in 3GPP TS 38.331). The ANR optimization function can analyze the performance data to determine whether to update the neighbor cell relation table. If an update is required, the function can determine the action for the neighbor cell relation table update. For example, a neighbor cell with weak RSRP measurements may indicate that a relation with this neighbor cell is no longer valid, and can be deleted from the neighbor cell relation table. A neighbor candidate cell with strong RSRP measurements may indicate that a relation with this neighbor candidate cell is valid, and should be added to the neighbor cell relation table. In some implementations, whether a RSRP measurement is strong or weak can be determined based on one or more thresholds. For example, weak RSRP measurements can be associated with values that are less than a minimum threshold value. Strong RSRP measurements can be associated with values that are greater than a threshold value.

The ANR optimization function can consume the management service for NF provisioning with one of the following operations to execute the action if necessary: operation createMOI to add a new relation to the neighbor cell relation table of the given cell; operation modifyMOIAttributes to modify the attributes in the neighbor cell relation table of Cell #A, or to remove a neighbor cell relation table from the given cell; operation deleteMOI to remove the relation from the neighbor cell relation table of the given cell (see, e.g., clause 5.1.4 in 3GPP TS 28.832).

A wireless network can configure PCI values within the network. As noted above, each gNB can be assigned a PCI that is broadcast in the PSS and SSS. When an UE receives PSS and SSS to acquire time and frequency synchronization, it also obtains the PCI that is used to uniquely identify an NR cell. PCIs can be reused. Due to the addition of new cells or changes of neighbor relations from ANR functions, problems can arise such as PCI collision or PCI confusion. The PCIs of NR cells which are newly deployed can be configured automatically by a network. Further, a network can reconfigure the PCIs of NR cells that are impacted by PCI issues such as PCI collision or confusion. In some implementations, a PCI optimization function (which can be located in a 3GPP management system) can be deployed and activated. The PCI optimization function can be a consumer of a NG-RAN provisioning management service or NG-RAN fault management services related to PCI collision or confusion.

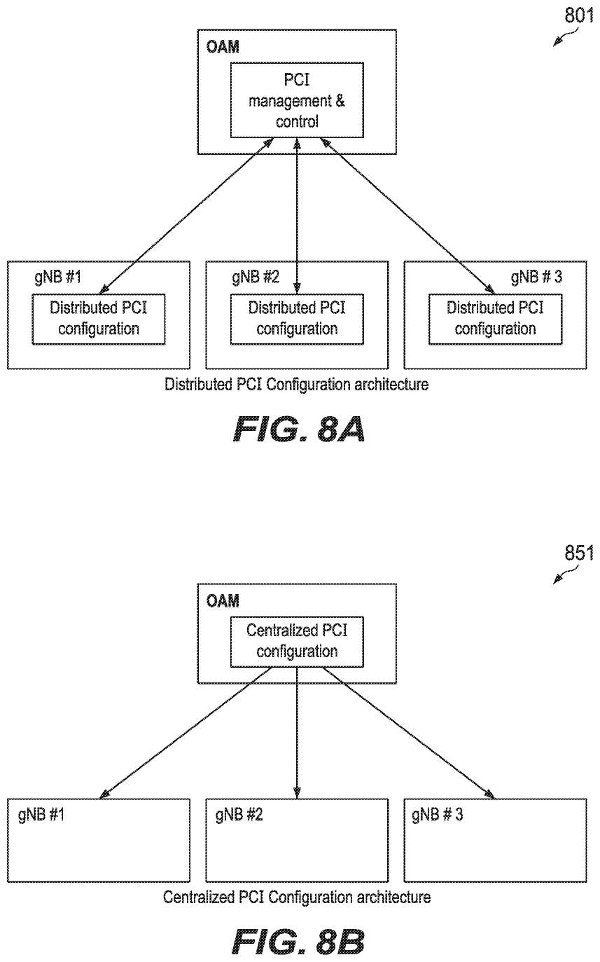

FIGS. 8A and 8B illustrate diagrams of different examples of PCI configuration architectures. PCI configuration can be distributed, centralization, or a combination thereof.

FIG. 8A illustrates a diagram of an example of a distributed PCI configuration architecture 801 for a D-SON. A network can use a distributed PCI configuration. In a D-SON, a distributed PCI configuration can be deployed in the gNB of each NR cell, and an OAM system can provide a PCI management and control function.

In some implementations, the PCI management and control function sets a list of PCI values to be used by a NR cell, and activates the distributed PCI configuration function. The distributed PCI configuration function can randomly select a PCI value from the list of PCI values provided by the PCI management and control function. The distributed PCI configuration function can report the PCI value selected for this NR cell to the PCI management and control function.

The PCI management and control function can consume the management service for NF provisioning with modifyMOIAttributes operation to configure the PCI list in the IOC NRCellDU for a given NR cell (see, e.g., clause 6.3 in TS 28.531). The NRCellDU is an IOC that represents a part of NR cell information that describes the specific resources instances. The PCI management and control function can consume the management service for NF provisioning with modifyMOIAttributes operation to activate the distributed PCI configuration function for a given NR cell. The distributed PCI configuration function can randomly select a PCI value from the PCI list, and can use the producer of the management service for NF provisioning to send a notification notifyMOIAttributeValueChange (see, e.g., 3GPP TS 28.532), indicating the PCI value being selected, to the PCI management and control function. The PCI management and control function can consume the management service for NF provisioning with modifyMOIAttributes operation to configure the attribute nRPCI in the IOC NRCellDU with the PCI value provided by the PCI management and control function. The attribute nRPCI holds the PCI of the NR cell.

FIG. 8B illustrates a diagram of an example of a centralized PCI architecture 851 for a C-SON. A network can use a centralized PCI configuration. In a C-SON, a centralized PCI configuration function can be deployed in the OAM system. In some implementations, the centralized PCI configuration function monitors and collects the PCI related data such as measurements related to measurement report, such as physCellId, MeasQuantityResults, which are generated from the MeasResultNR reported by a NG-RAN (see, e.g., clause 6.3.2 in TS 38.331). MeasQuantityResults can include a RSRP, reference signal received quality (RSRQ), and signal-to-noise and interference ratio (SINR) values. Other values are possible. The centralized PCI configuration function analyzes the PCI related information to detect newly deployed NG-RAN or PCI collision or confusion among the NR cells. The centralized PCI configuration function can consume a NG-RAN provisioning service to configure a specific PCI value or a list of values for each newly deployed NR cell or reconfigure a PCI value or a list of values for the NG-RAN cell which is in the problem of PCI collision or confusion. The NG-RAN can perform PCI selection according to the configured specific PCI or list of PCIs. If the newly deployed NR-RAN cell is not correctly configured or PCI collision or confusion is not resolved, the centralized PCI configuration function can select a new PCI value. PCI configuration can end when the new deployed NG-RAN cells are configured successfully or the NG-RAN cells are taken out of service or when the centralized PCI configuration function is stopped.

In some implementations, it can be assumed that the centralized PCI configuration function has consumed the management service to collect PCI related measurements, and the IOC NRCellDU representing the NR cell undertaking the PCI configuration has been created. The centralized PCI configuration function may be initiated periodically as a preventive maintenance, to detect PCI conflict or confusion, as NR cells are coming up and down, due to energy saving, or new deployment.

The centralized PCI configuration function can collect the PCI related measurements reported by a NG-RAN. In some implementations, the measurements related to a measurement report, such as physCellId, MeasQuantityResults, which are generated from the MeasResultNR can be reported by a gNB (see, e.g., clause 6.3.2 in TS 38.331). The centralized PCI configuration function can analyze the PCI related information to detect a newly deployed NR cell or NR cells experiencing PCI collisions or confusion. The centralized PCI configuration function can consume the management service for NF provisioning with modifyMOIAttributes operation (see, e.g., clause 6.3 in 3GPP TS 28.531) to configure a specific PCI value or a list of values for the newly deployed NR cell or reconfigure a PCI value or a list of values for the NR cell(s) experiencing PCI collisions or confusion. In some implementations, the PCI management and control function consumes the management service for NF provisioning with modifyMOIAttributes operation to deactivate the distributed PCI configuration function for a given NR cell.

In some implementations, the centralized PCI configuration function has a capability to collect the information related to PCI collision or PCI confusion. In some implementations, the centralized PCI configuration function has a capability to change the PCIs of one or more NR cells. In some implementations, the PCI configuration management and control function has a capability to set the list of PCI values for a NR cell. In some implementations, the PCI configuration management and control function has a capability to activate or deactivate the distributed PCI configuration function for a NR cell.

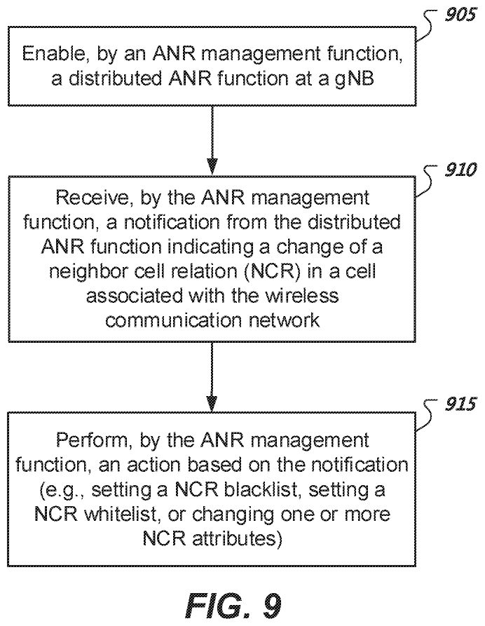

FIG. 9 illustrates a flowchart of a process performed by a distributed ANR management function in a wireless network. At 905, the distributed ANR management function can enable a distributed ANR function at a gNB. In some implementations, multiple distributed ANR functions can be enabled. In some implementations, a OAM system can send a command to enable a distributed ANR function at a gNB. At 910, the distributed ANR management function can receive a notification from the distributed ANR function indicating a change of a neighbor cell relation in a cell associated with the wireless network. In some implementations, the gNB can generate the notification based on detecting a change in cell performance measurements. At 915, the ANR management function can perform an action based on the notification. Performing the action can include setting a NCR blacklist, setting a NCR whitelist, changing one or more NCR attributes, or other actions.

An ANR management function supported by one or more processors and configured to enable a distributed ANR function; receive a notification from the distributed ANR function indicating the changes of neighbor cell relation in a NR cell; and perform an action such as set the blacklist and/or whitelists of neighbor cell relations, change the attributes of a neighbor cell relation, or both. If the distributed ANR function is running, the function can detect a new inter or intra neighbor cell relation, and can add the relation to the neighbor cell relation table. If the distributed ANR function detects that an existing inter or intra neighbor cell relation has been removed, and the function can delete the relation from the neighbor cell relation table.

In some implementations, the distributed ANR function uses the producer of the management service for NF provisioning and can send a notification such as a notifyMOICreation to notify the ANR management function that a new neighbor cell relation has been added to the table, or notifyMOIDeletion to notify the ANR management function that an existing neighbor cell relation has been removed from the table. In some implementations, the ANR management function consumes the management service for NF provisioning with operation modifyMOIAttributes to modify the ANR attributes, e.g., whether HO or relation removal is allowed. In some implementations, the ANR management function consumes the management service for NF provisioning with operation createMOI to add a whitelist or blacklist to the neighbor cell relation table.

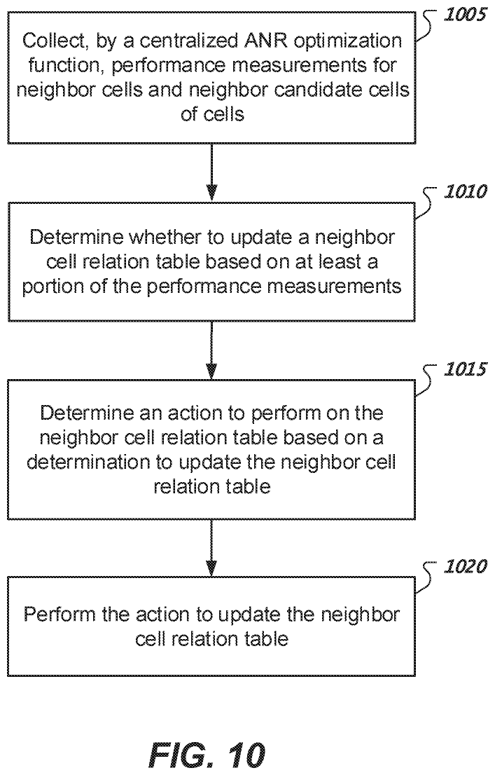

FIG. 10 illustrates a flowchart of a process performed by a centralized ANR optimization function in a wireless network. The ANR optimization function can be triggered periodically or triggered based on a detection that a cell of the wireless communication network is experiencing performance issues with respect to another cell of the wireless communication network. At 1005, a centralized ANR optimization function can collect performance measurements for neighbor cells and neighbor candidate cells of cells. The performance measurements can include RSRP measurement results. The RSRP measurement results can be generated from a measurement result list report for intra-RAT or inter-RAT relations such as the MeasResultListNR or MeasResultListEUTRA reports.

At 1010, the centralized ANR optimization function can determine whether to update a neighbor cell relation table based on at least a portion of the performance measurements. In some implementations, the determination at 101 can be based on a detection of performance issues among NR cells. At 1015, the centralized ANR optimization function can determine an action to perform on the neighbor cell relation table based on a determination to update the neighbor cell relation table. Determining the action to perform on the neighbor cell relation table can include determining that the action is a delete action based on a determination that one or more RSRP measurement values of a neighbor cell are less than a threshold. Determining the action to perform on the neighbor cell relation table can include determining that the action is an add action based on a determination that one or more RSRP measurement values of a neighbor candidate cell are greater than a threshold. At 1020, the centralized ANR optimization function can perform the action to update the neighbor cell relation table.

A wireless network in some implementations can include a centralized ANR optimization function supported by one or more processors and configured to collect performance measurements for neighbor cells and neighbor candidate cells of a cell, analyze the performance measurements to determine whether to update a neighbor cell relation table; determine the action for neighbor cell relation table update; and execute the action to update the table. In some implementations, the centralized ANR optimization function can be initiated periodically as a preventive maintenance, or when it is detected that a given cell is experiencing performance issues.

In some implementations, the performance measurements includes statistics of RSRP measurement results that can be generated from the MeasResultListNR for intra-RAT neighbor relations, or MeasResultListEUTRA for inter-RAT neighbor relations. In some implementations, the centralized ANR optimization function can determine the action based on the following criteria a neighbor cell with weak RSRP measurements may indicate that a relation with this neighbor cell is no longer valid, and can be deleted from the neighbor cell relation table update; and a neighbor candidate cell with strong RSRP measurements may indicate that a relation with this neighbor candidate cell is valid, and should be added to the neighbor cell relation table.

In some implementations, the centralized ANR optimization function can be configured to: add a new relation to the neighbor cell relation table by using operation createMOI to create an IOC NRCellRelation; modify an attribute in the neighbor cell relation table by using operation modifyMOIAttributes to modify an OC NRCellRelation; or remove the relation from the neighbor cell relation table by using operation deleteMOI to delete the IOC NRCellRelation.

In some implementations, a distributed PCI configuration function can be configured to receive a list of PCI values to be used by a NR cell from the PCI management and control function; select randomly a PCI value from the list of PCI values provided by PCI management and control function; and send a notification, indicating the PCI value being selected, to the PCI management and control function. In some implementations, the distributed PCI configuration function uses the producer of the management service for NF provisioning to send a notification notifyMOIAttributeValueChange. In some implementations, the distributed PCI configuration function is enabled by the PCI management and control function.

A network can include a centralized PCI configuration function supported by one or more processors and configured to collect the PCI related measurements; analyze the PCI related information to detect a newly deployed NR cell or NR cells experiencing PCI conflict or confusion; and configure a specific PCI value or a list of values for the newly deployed NR cell or re-configure a PCI value or a list of values for the NR cell(s). In some implementations, the centralized PCI configuration function can be initiated periodically as a preventive maintenance, to detect PCI conflict or confusion, as NR cells are coming up and down, due to energy saving, or new deployment. In some implementations, the PCI related measurements can include the measurements related to measurement report, such as physCellId, MeasQuantityResults, which are generated from the MeasResultNR reported by NG-RAN. In some implementations, the centralized PCI configuration function consumes the management service for NF provisioning with modifyMOIAttributes operation to configure the PCI values for the NR cell(s) experiencing a PCI conflict or confusion.

A technique used in a wireless network can include receiving a notification from a distributed ANR function, the notification indicating a change to a neighbor cell relation in a NR cell; and modifying a parameter in response to the notification. Modifying the parameter can include setting a neighbor cell relation blacklist. Modifying the parameter can include setting a neighbor cell relation whitelist. Modifying the parameter can include changing an attribute associated with the neighbor cell relation. In some implementations, the notification is received from a gNB. The technique can be performed by network equipment such as an OAM system.

Another technique used in a wireless network can include receiving a message from a gNB, the message including a plurality of PCI values for a NR cell; selecting a PCI value from the plurality of PCI values; and encoding a notification message including an indication of the selected PCI value for transmission to the gNB. In some implementations, the plurality of PCI values are received from a PCI management and control function operating on the gNB. The technique can be performed by network equipment such as an OAM system.

These and other techniques can be performed by an apparatus that is implemented in or employed by one or more types of network components, user devices, or both. In some implementations, one or more non-transitory computer-readable media comprising instructions to cause an electronic device, upon execution of the instructions by one or more processors of the electronic device, to perform one or more of the described techniques. An apparatus can include one or more processors and one or more computer-readable media comprising instructions that, when executed by the one or more processors, cause the one or more processors to perform one or more of the described techniques.

The methods described here may be implemented in software, hardware, or a combination thereof, in different implementations. In addition, the order of the blocks of the methods may be changed, and various elements may be added, reordered, combined, omitted, modified, and the like. Various modifications and changes may be made as would be obvious to a person skilled in the art having the benefit of this disclosure. The various implementations described here are meant to be illustrative and not limiting. Many variations, modifications, additions, and improvements are possible. Accordingly, plural instances may be provided for components described here as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component.

The methods described herein can be implemented in circuitry such as one or more of: integrated circuit, logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), or some combination thereof. Examples of processors can include Apple A-series processors, Intel® Architecture Core™ processors, ARM processors, AMD processors, and Qualcomm processors. Other types of processors are possible. In some implementations, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry. Circuitry can also include radio circuitry such as a transmitter, receiver, or a transceiver.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method of automatic neighbor relation (ANR) in a wireless communication network, the method comprising:
enabling, by an ANR management function performed by one or more processors, a distributed ANR function at a node in the wireless communication network;
receiving, by the ANR management function, a notification from the distributed ANR function indicating a change of a neighbor cell relation in a cell associated with the wireless communication network; and
performing, by the ANR management function, an action based on the notification, wherein performing the action comprises setting a blacklist of one or more neighbor cell relations, setting a whitelist of one or more neighbor cell relations, or changing one or more attributes of one or more neighbor cell relations.

2. The method of claim 1, comprising:
detecting, by the distributed ANR function, a new neighbor cell relation based on the notification; and
performing an update to a neighbor cell relation table by adding the new neighbor cell relation to the neighbor cell relation table, wherein the new neighbor cell relation is an inter or intra neighbor cell relation.

3. The method of claim 2, comprising:
sending, by the distributed ANR function, a notify creation message to notify the ANR management function that the new neighbor cell relation has been added to the neighbor cell relation table.

4. The method of claim 1, comprising:
detecting, by the distributed ANR function, that an existing neighbor cell relation has been removed based on the notification; and
performing an update to a neighbor cell relation table by deleting the existing neighbor cell relation from the neighbor cell relation table, wherein the existing neighbor cell relation is an inter or intra neighbor cell relation.

5. The method of claim 4, comprising:
sending, by the distributed ANR function, a notify deletion message to notify the ANR management function that the existing neighbor cell relation has been removed from the neighbor cell relation table.

6. The method of claim 1, wherein the ANR management function consumes a management service for network function provisioning with a modify managed object instance (MOI) attributes operation to modify one or more ANR attributes, the one or more ANR attributes collectively comprise an attribute to control whether the node is allowed to remove a neighbor cell relation from a neighbor cell relation table, an attribute to control whether the node is allowed to use a neighbor cell relation for a handover, or both.

7. The method of claim 1, wherein the ANR management function consumes a management service for network function provisioning with a create managed object instance (MOI) operation to add whitelist or blacklist information to a neighbor cell relation table.

8. The method of claim 1, wherein the cell comprises a new radio (NR) cell, and wherein the node comprises a next-generation NodeB (gNB).

9. The method of claim 8, comprising:
receiving, by a distributed physical cell identity (PCI) configuration function performed by the node, a list of PCI values for use by a NR cell from a PCI management and control function;
selecting a PCI value from the list of PCI values received from the PCI management and control function; and
sending, to the PCI management and control function, a notification that indicates the selected PCI value.

10. The method of claim 9, wherein the distributed PCI configuration function uses a producer of a management service for network function provisioning to send a notification regarding an attribute value change for a managed object instance.

11. The method of claim 10, wherein the distributed PCI configuration function is enabled by the PCI management and control function.

12. A method of automatic neighbor relation (ANR) in a wireless communication network, the method comprising:
collecting, by a centralized ANR optimization function performed by one or more processors of the wireless communication network, performance measurements for neighbor cells and neighbor candidate cells of a cell;
determining whether to update a neighbor cell relation table based on at least a portion of the performance measurements;
determining an action to perform on the neighbor cell relation table based on a determination to update the neighbor cell relation table; and
performing the action to update the neighbor cell relation table.

13. The method of claim 12, wherein the neighbor cells comprise a new radio (NR) cell, and wherein the wireless communication network comprises a next-generation NodeB (gNB) that controls the NR cell.

14. The method of claim 12, wherein the wireless communication network comprises a first radio access technology (RAT) and a second RAT, wherein the performance measurements comprise reference signal received power (RSRP) measurement results, wherein the RSRP measurement results are generated from a measurement result list report in accordance with the first RAT for intra-RAT neighbor relations, or a measurement result list report in accordance with the second RAT for inter-RAT neighbor relations.

15. The method of claim 12, wherein determining the action to perform on the neighbor cell relation table comprises:
determining that the action is a delete action based on a determination that one or more RSRP measurement values of a neighbor cell are less than a threshold; or
determining that the action is an add action based on a determination that one or more RSRP measurement values of a neighbor candidate cell are greater than a threshold.

16. The method of claim 12, wherein the centralized ANR optimization function is configured to perform operations comprising:
adding a new relation to the neighbor cell relation table by performing a create managed object instance (MOI) operation to create an information object class (IOC) that represents a neighbor cell relation from a source cell to a target cell;
modifying an attribute in the neighbor cell relation table by performing a modify MOI attributes operation to modify an IOC that represents a neighbor cell relation from a source cell to a target cell; or
removing an existing relation from the neighbor cell relation table by performing a delete MOI operation to delete an IOC that represents the existing neighbor cell relation from a source cell to a target cell.

17. The method of claim 12, wherein the ANR optimization function is triggered periodically, or wherein the ANR optimization function is triggered based on a detection that a cell of the wireless communication network is experiencing performance issues with respect to another cell of the wireless communication network.

18. The method of claim 12, comprising:
collecting, by a centralized physical cell identity (PCI) configuration function, PCI related measurements;
detecting, based on the PCI related measurements, a newly deployed new radio (NR) cell or a NR cell associated with a PCI conflict; and
configuring a specific PCI value or a list values for the newly deployed NR cell or reconfiguring a PCI value or a list values for the NR cell associated with the PCI conflict.

19. The method of claim 18, wherein the centralized PCI configuration function is triggered periodically, or wherein the centralized PCI configuration function is triggered based on a detection that a cell of the wireless communication network is associated with a PCI conflict, or wherein the centralized PCI configuration function is triggered based on an activation or deactivation of one or more NR cells.

20-21. (canceled)

22. A system comprising:
one or more processors; and
one or more computer-readable media comprising instructions that, when executed by the one or more processors, cause the one or more processors to perform operations comprising:
enabling, by an automatic neighbor relation (ANR) management function, a distributed ANR function at a node in a wireless communication network;
receiving, by the ANR management function, a notification from the distributed ANR function indicating a change of a neighbor cell relation in a cell associated with the wireless communication network; and
performing, by the ANR management function, an action based on the notification, wherein performing the action comprises setting a blacklist of one or more neighbor cell relations, setting a whitelist of one or more neighbor cell relations, or changing one or more attributes of one or more neighbor cell relations.

23-42. (canceled)
